(19) United States
(12) Patent Application Publication
(10) Pub. No.: US 2026/0192752 A1
(43) Pub. Date: Jul. 9, 2026

(54) STEP MOUNTING ASSEMBLY, RETRACTABLE STEP DEVICE AND VEHICLE APPARATUS

(71) Applicant: T-MAX (HANGZHOU) TECHNOLOGY CO., LTD., Hangzhou (CN)

(72) Inventors: Xinfa DU, Hangzhou (CN); Ke WANG, Hangzhou (CN); Hanxin ZHANG, Hangzhou (CN)

(21) Appl. No.: 19/442,738

(22) Filed: Jan. 7, 2026

(30) Foreign Application Priority Data
Jan. 7, 2025 (CN) 202510024622.6
Jan. 7, 2025 (CN) 202510025287.1
Jan. 7, 2025 (CN) 202510025667.5
Jan. 7, 2025 (CN) 202510026758.0
Jan. 7, 2025 (CN) 202520033476.9
Jan. 7, 2025 (CN) 202520035005.1
Jan. 7, 2025 (CN) 202520035773.7
Jan. 7, 2025 (CN) 202520035780.7
Jan. 7, 2025 (CN) 202520037343.9

(51) Int. Cl. B60R 3/02

(52) U.S. Cl. CPC B60R 3/02

(57) ABSTRACT

Disclosed are a step mounting assembly and a retractable step device in accordance with the present technology. The step mounting assembly comprises a first support arm, a second support arm, and a step bracket, wherein the step bracket has a first side and a second side oriented away from each other in a transverse direction of the step bracket, at least one of the first side and the second side can be connected to a step, the first support arm is pivotally connected to the step bracket, and the second support arm is pivotally connected to the step bracket to move the step connected to the step bracket between an extended position and a retracted position.

### CROSS-REFERENCE TO RELATED APPLICATIONS

This patent document claims priority to and benefits of Chinese Patent Application No. 2025100246226 filed on Jan. 7, 2025, Chinese Patent Application No. 2025100252871 filed on Jan. 7, 2025, Chinese Patent Application No. 2025100256675 filed on Jan. 7, 2025, Chinese Patent Application No. 2025100267580 filed on Jan. 7, 2025, Chinese Patent Application No. 2025200357737 filed on Jan. 7, 2025, Chinese Patent Application No. 2025200373439 filed on Jan. 7, 2025, Chinese Patent Application No. 2025200357807 filed on Jan. 7, 2025, Chinese Patent Application No. 2025200350051 filed on Jan. 7, 2025, and Chinese Patent Application No. 2025200334769 filed on Jan. 7, 2025, the entire contents of which are incorporated herein by reference.

### TECHNICAL FIELD

The present technology relates to the technical field of vehicles, in particular to a step mounting assembly, a retractable step device, and a vehicle apparatus.

### BACKGROUND

A retractable step for a vehicle is usually installed under the vehicle to assist a passenger in getting into and out of the vehicle. In the related arts, the retractable step needs a large installation space, which is problematic because, especially for a vehicle with a low chassis, the retractable step is inconvenient to install and the vehicle's passability is affected.

### SUMMARY

Disclosed are a step mounting assembly and a retractable step device in accordance with the present technology.

In some aspects, a step mounting assembly includes a first support arm; a second support arm; and a step bracket having a first side and a second side that are oriented away from each other in a transverse direction of the step bracket, wherein at least one of the first side and the second side is connectable to a step, the first support arm is pivotally connected to the step bracket, and the second support arm is pivotally connected to the step bracket, to allow the step bracket and the step connected to the step bracket to move between an extended position and a retracted position.

In some aspects, a retractable step device includes at least one step having a tread surface; and a plurality of step mounting assemblies, each step mounting assembly comprising: a first support arm; a second support arm; and a step bracket having a first side and a second side that are oriented away from each other in a transverse direction of the step bracket, wherein at least one of the first side and the second side is connected to the at least one step, the first support arm is pivotally connected to the step bracket, and the second support arm is pivotally connected to the step bracket, to allow the step bracket and the at least one step connected to the step bracket to move between an extended position and a retracted position, wherein in step brackets of adjacent step mounting assemblies, a first side of one step bracket faces a second side of another step bracket, and the at least one step is connected between the first side of the one step bracket and the second side of the another step bracket.

In some aspects, a vehicle apparatus includes a vehicle and an example embodiment of a retractable step device in accordance with the present technology. The retractable step device comprises at least one step having a tread surface and a plurality of step mounting assemblies, and each step mounting assembly comprises: a first support arm and a second support arm, the first support arm and the second support arm being respectively pivotally connected to a bottom of a body of the vehicle; and a step bracket having a first side and a second side that are oriented away from each other in a transverse direction of the step bracket, wherein at least one of the first side and the second side is connected to the at least one step, the first support arm is pivotally connected to the step bracket, and the second support arm is pivotally connected to the step bracket, to allow the step bracket and the at least one step connected to the step bracket to move between an extended position and a retracted position, wherein in step brackets of adjacent step mounting assemblies, a first side of one step bracket faces a second side of another step bracket, and the at least one step is connected between the first side of the one step bracket and the second side of the another step bracket.

### BRIEF DESCRIPTION OF THE DRAWINGS

FIG. 1 is an exploded view of a retractable step device according to an embodiment of the present technology.

FIG. 2 is a schematic view of a retractable step device according to an embodiment of the present technology where the step is in an extended position.

FIG. 3 is a schematic view of a retractable step device according to an embodiment of the present technology where the step is in a retracted position.

FIG. 4 is a schematic view of a step mounting assembly according to an embodiment of the present technology.

FIG. 5 is an exploded view of a step mounting assembly according to an embodiment of the present technology.

FIG. 6 is a schematic view of a step mounting assembly according to an embodiment of the present technology.

FIG. 7 is another schematic view of a step mounting assembly according to an embodiment of the present technology.

FIG. 8 is a schematic view of a step bracket according to an embodiment of the present technology.

FIG. 9 is another schematic view of a step bracket according to an embodiment of the present technology.

FIG. 10 is a schematic view of a first support arm of a step mounting assembly according to an embodiment of the present technology.

FIG. 11 is a schematic view of a second support arm of a step mounting assembly according to an embodiment of the present technology.

FIG. 12 is another schematic view of the second support arm of the step mounting assembly according to an embodiment of the present technology.

FIG. 13 is a cross-sectional view of a retractable step device and a side rail mounted on a vehicle, where the retractable step device is in an extended position, according to an embodiment of the present technology.

FIG. 14 is a cross-sectional view of a retractable step device and a side rail mounted on a vehicle, where the retractable step device is in a retracted position, according to an embodiment of the present technology.

FIG. 15 is a cross-sectional view of a retractable step device mounted on a vehicle, where the retractable step device is in an extended position, according to an embodiment of the present technology.

FIG. 16 is a cross-sectional view of a retractable step device mounted on a vehicle, where the retractable step device is in a retracted position, according to an embodiment of the present technology.

FIG. 17 is an exploded view of a retractable step device according to another embodiment of the present technology.

FIG. 18 is a schematic view of a retractable step device according to another embodiment of the present technology.

FIG. 19 is an exploded view of a retractable step device according to yet another embodiment of the present technology.

FIG. 20 is a schematic view of a step mounting assembly according to yet another embodiment of the present technology.

FIG. 21 is a schematic view of a step bracket according to yet another embodiment of the present technology.

FIG. 22 is another schematic view of a step bracket according to yet another embodiment of the present technology.

FIG. 23 is an exploded view of a retractable step device according to a further embodiment of the present technology.

FIG. 24 is a schematic view of a retractable step device according to a further embodiment of the present technology.

FIG. 25 is a schematic view of a step mounting assembly according to a further embodiment of the present technology.

FIG. 26 is a schematic view of a step bracket according to a further embodiment of the present technology.

FIG. 27 is an exploded view of a retractable step device according to yet a further embodiment of the present technology.

### DETAILED DESCRIPTION

Hereinafter, embodiments in accordance with the present technology will be described in detail and are illustrated through the examples in the accompanying drawings. The embodiments described below, which may refer to the drawings, are examples and are intended to explain the disclosed technology, but are not to be construed as limiting the disclosed technology.

A step bracket, a step mounting assembly, a retractable step device, and a vehicle apparatus according to embodiments of the present technology are described in the following with reference to the accompanying drawings.

The vehicle apparatus according to some example embodiments of the present technology includes a vehicle 2000 and a retractable step device 1000. The retractable step device 1000 is mounted on the vehicle 2000 and is movable between an extended position and a retracted position to assist passengers in entering and exiting the vehicle.

Below are some example embodiments of the retractable step device 1000.

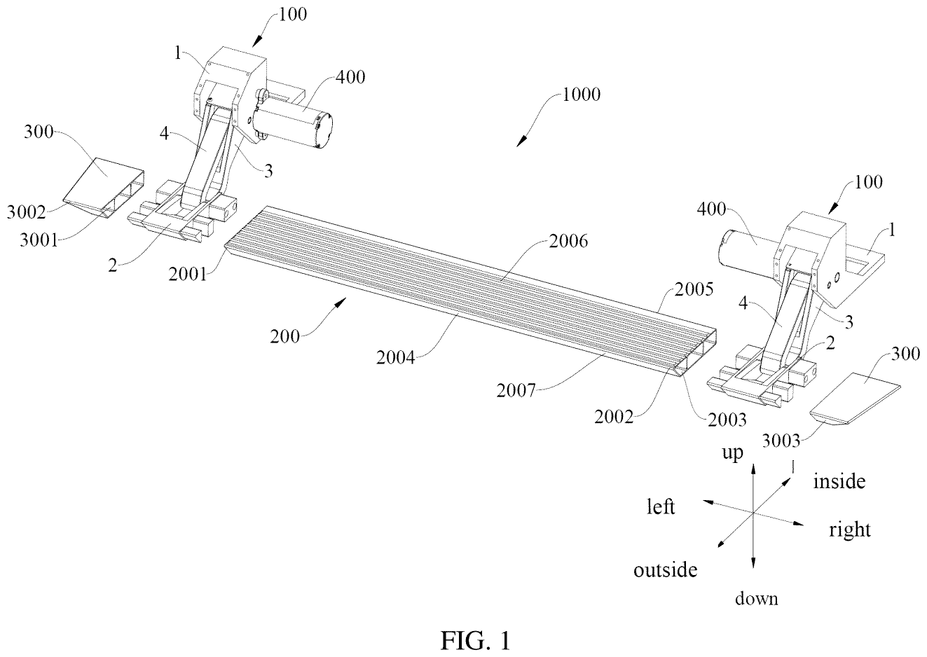

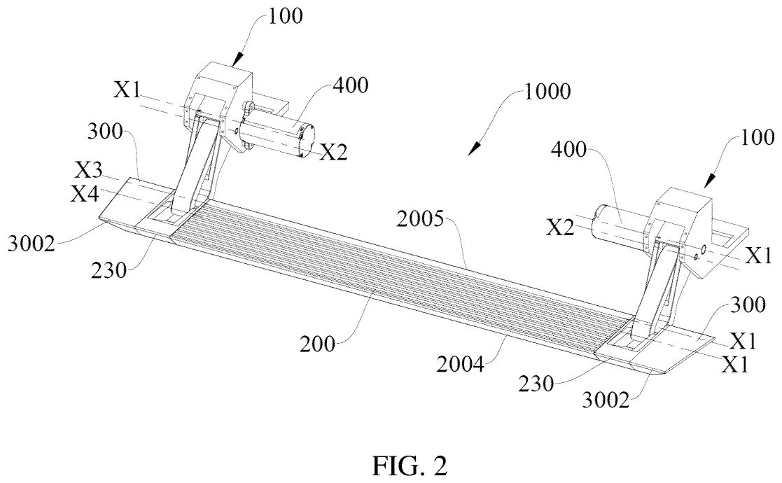

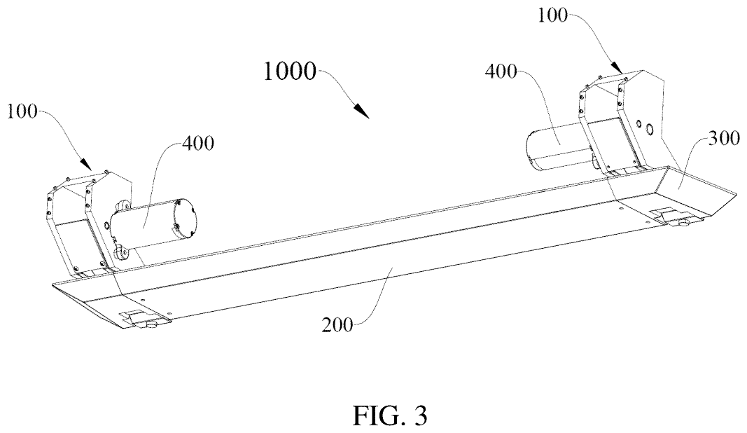

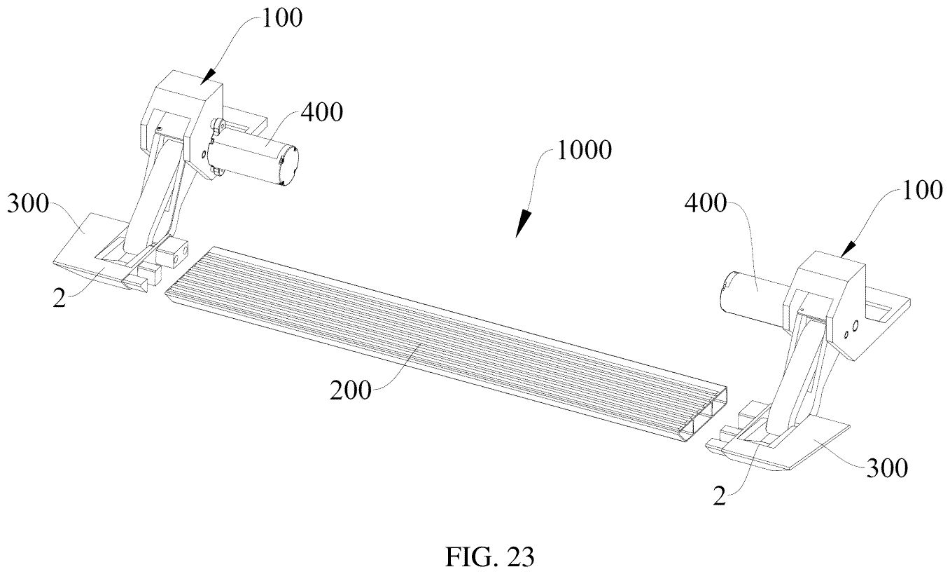

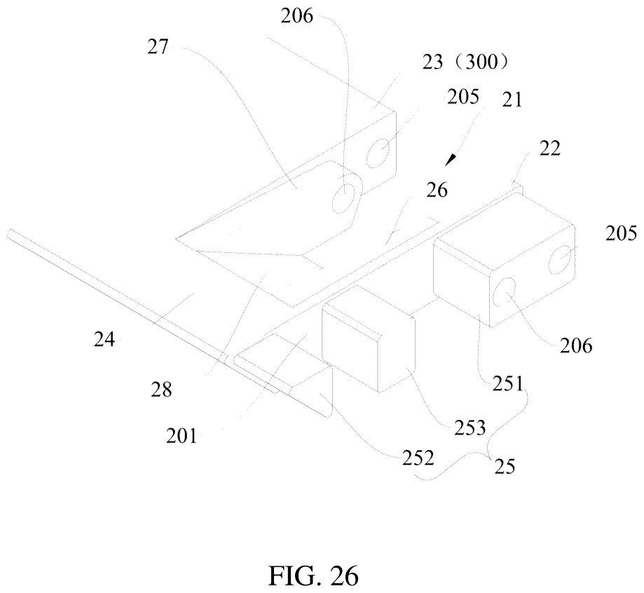

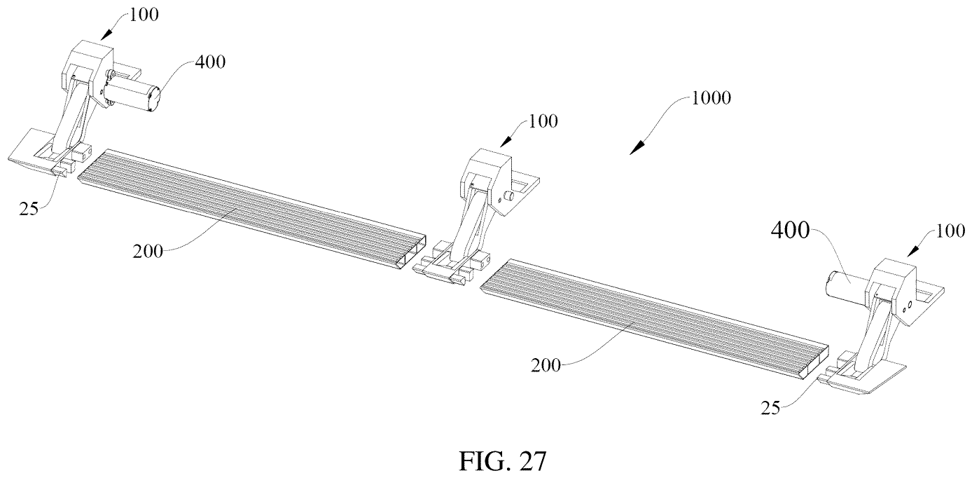

FIGS. 1 to 27 illustrate various example embodiments of the retractable step device 1000 mountable to the vehicle 2000. Example embodiments of the retractable step device 1000 are shown, which can include a step 200 and a step mounting assembly 100.

In some embodiments in accordance with the present technology, the retractable step device 1000 can be mounted on at least one of a left side and a right side of the vehicle 2000, or on a rear side of the vehicle 2000. In the following description of embodiments, the retractable step device 1000 is mounted on the left side of the vehicle 2000.

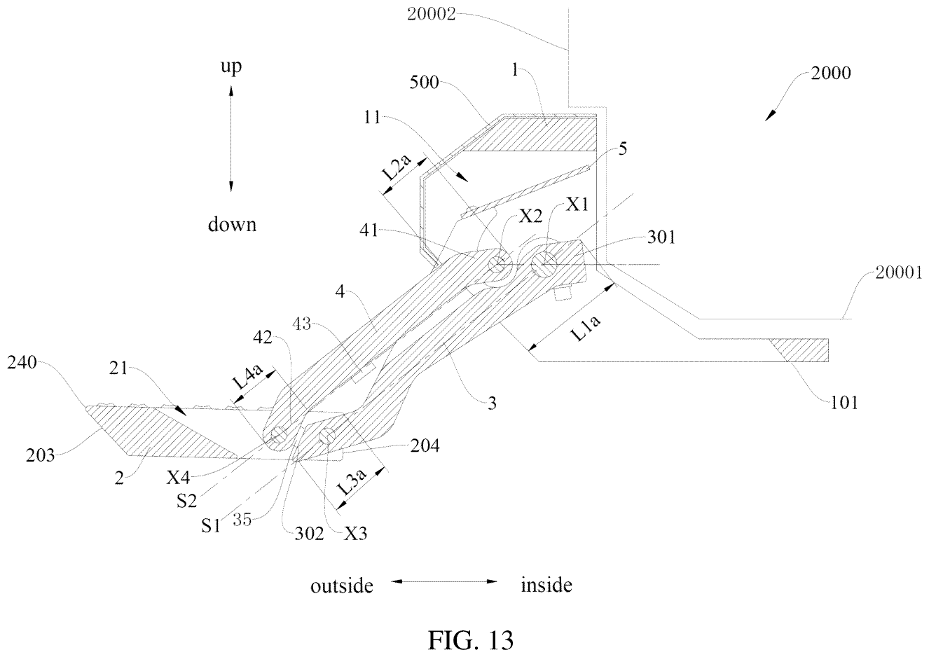

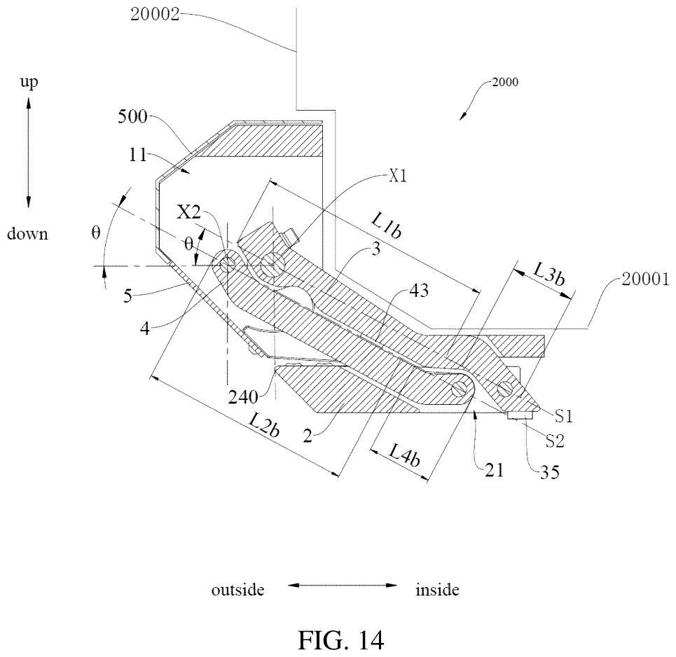

As shown in FIGS. 13 and 14, in some embodiments, the vehicle apparatus also includes a side rail 500. The side rail 500 is mounted on the vehicle 2000, for example, along the lower edges of the left and right sides of the vehicle 2000, to protect the sides of the vehicle. Optionally, the side rail 500 can also be used to secure the step. The retractable step device 1000 is mounted on the underside 20001 (e.g., bottom) of the vehicle body of the vehicle 2000. When in the retracted position, the step 200 is located below and at the inner side of the side rail 500. When in the extended position, the step 200 is located below the side rail 500 and at least partially at the outer side of the side rail 500. Thus, the side rail 500 not only protects the vehicle and the retractable step device, but also optionally serves as a fixed step, and the side rail and the retractable step device form a two-tier step structure, which is particularly suitable for vehicles with a high chassis.

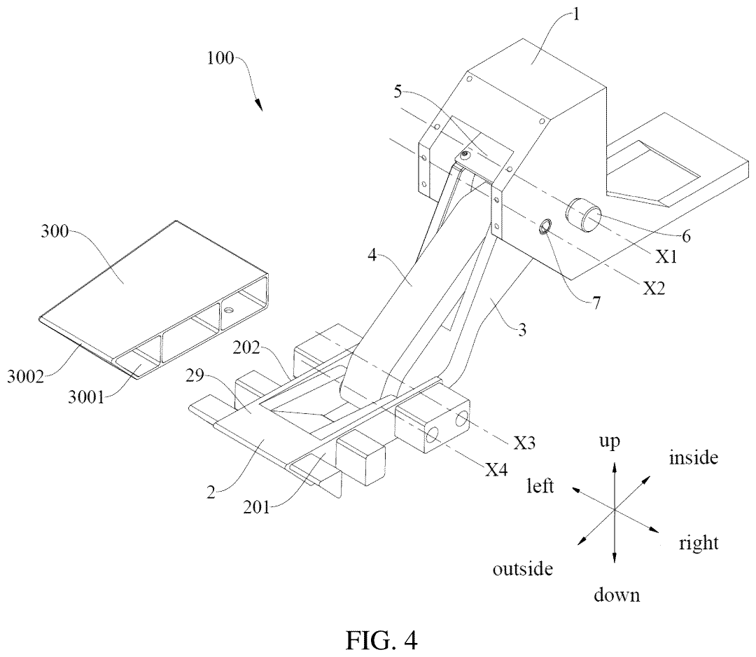

As shown in FIGS. 1 to 3, the retractable step device 1000 according to some embodiments of the present technology includes a step mounting assembly 100 and a step 200. The step 200 is mounted on the step mounting assembly 100 to move between the extended position and the retracted position. The step mounting assembly 100 includes a step bracket 2 connected to the step 200. As shown in FIG. 4, the transverse direction of the step bracket 2 is parallel to the length direction of the step 200, for example, the transverse direction of the step bracket 2 is the left-right direction in FIG. 4.

When the retractable step device 1000 is mounted on the left or right side of the vehicle 2000, the transverse direction of the step bracket 2 is consistent with the front-back direction of the vehicle 2000, and the left-right direction of the step 200 is consistent with the front-back direction of the vehicle 2000. The outer side (outer end) of the step bracket 2 refers to the side of the step bracket 2 that is away from the vehicle 2000 along the left-right direction of the vehicle. The inner side (inner end) of the step bracket 2 refers to the side of the step bracket 2 that is close to the vehicle 2000 along the left-right direction of the vehicle.

When the retractable step device 1000 is mounted on the rear side of the vehicle, the transverse direction of the step bracket 2 is consistent with the left-right direction of the vehicle 2000, and the length direction of the step 200 is consistent with the left-right direction of the vehicle 2000. The outer side (outer end) of the step bracket 2 refers to the side of the step bracket 2 away from the vehicle 2000, and the inner side (inner end) of the step bracket 2 refers to the side of the step bracket 2 close to the vehicle 2000.

In the extended position, the step 200 and the step bracket 2 extend outward beyond the outer edge 20002 of the vehicle body to facilitate the user stepping on the step 200. In the retracted position, the step 200 and the step bracket 2 are retracted inside the outer edge 20002 of the vehicle body.

As shown in FIGS. 1 to 7, the step mounting assembly 100 according to some embodiments of the present technology includes a first support arm 3, a second support arm 4, and a step bracket 2. The step bracket 2 has a first side 201 and a second side 202 that are oriented away from each other in the transverse direction of the step bracket 2. As shown in FIG. 4, the first side 201 is the right side of the step bracket 2, and the second side 202 is the left side of the step bracket 2.

At least one of the first side 201 and the second side 202 is connectable to the step 200. The first support arm 3 is pivotally connected to the step bracket 2 and the second support arm 4 is pivotally connected to the step bracket 2, to move the step bracket 2 and the step 200 between the extended position and the retracted position.

The first support arm 3 and the second support arm 4 are both pivotally connected to the underside 20001 of the vehicle body of the vehicle 2000.

For example, the first support arm 3 and the second support arm 4 can be pivotally connected directly to the underside 20001 of the vehicle body of the vehicle 2000. In some embodiments, the first support arm 3 and the second support arm 4 are pivotally connected indirectly to the underside 20001 of the vehicle body of the vehicle 2000.

In some embodiments of the present technology, the first support arm 3, the second support arm 4, and the step bracket 2 form a linkage mechanism that can be connected to a drive device 400 so as to drive the step bracket 2 and the step 200 to move between the extended position and the retracted position. In other words, the drive device 400 can be connected to the first support arm 3 or the second support arm 4. In the illustrated embodiments, the drive device 400 is connected to the first support arm 3.

According to some embodiments of the step mounting assembly 100 of the present technology, since at least one of the first side 201 and the second side 202 of the step bracket 2 is connectable to the step 200, the overall thickness of the assembled step bracket 2 and step 200 in the up-down direction is relatively small in the extended position and especially small in the retracted position, and the required installation space for the step mounting assembly 100 is small, which is particularly suitable for vehicles with a low chassis. Therefore, the step mounting assembly 100 according to some embodiments of the present technology occupies a small space, has strong adaptability, and improves the vehicle's passability (e.g., ability of the vehicle to traverse objects or obstacles without interference from the step mounting assembly 100).

In the related art, the step 200 is usually mounted on the step bracket 2 in the thickness direction of the step 200 (i.e., the up-down direction of the vehicle 2000), meaning that the step bracket and the step are stacked in the up-down direction, which results in a large occupied space for the step 200 and the step bracket 2. For vehicles with a low chassis, the step 200 and the step bracket 2 in the related art are prone to collision with ground obstacles, resulting in a shorter service life.

In the step mounting assembly 100 according to some embodiments of the present technology, by connecting the step 200 to at least one of the first side 201 and the second side 202 of the step bracket 2, the step bracket 2 and the step 200 are substantially at the same horizontal level. In other words, the step bracket 2 and the step 200 are arranged side by side in the length direction of the step 200, which not only reduces the overall thickness of the assembled step bracket 2 and step 200, but also allows the upper surface of the step bracket 2 to be used for stepping, and therefore results in a more compact structure of the step mounting assembly 100, which is beneficial for improving space utilization and provides a better user experience.

In contrast to the related art where the support arm is directly connected to the step, in example embodiments in accordance with the present technology, the step mounting assembly 100 is pivotally connected to the step bracket 2 via the first support arm 3 and the second support arm 4, and the step 200 is connected to the step bracket 2, which, on the one hand, enhances the load-bearing capacity of the assembled step mounting assembly 100 and step 200, providing a more stable stepping experience for users and reducing the likelihood of damage. On the other hand, the step bracket 2 acts as an intermediary component, and may be pre-assembled into a single unit with the first support arm 3 and the second support arm 4 before leaving the manufacturing factory. The step mounting assembly 100 and the step 200 can be packaged and transported separately, thereby reducing transportation costs and simplifying the assembly process later on.

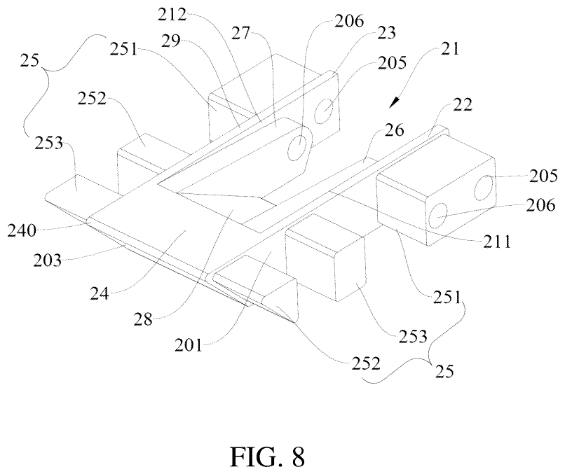

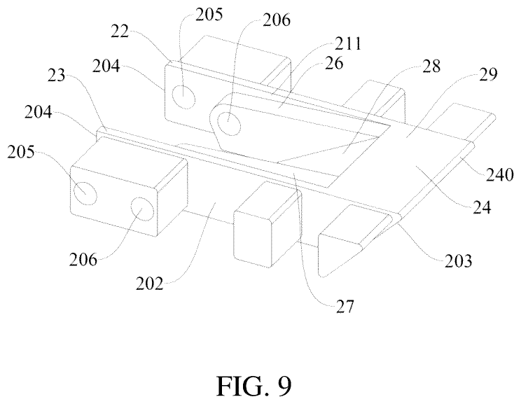

As shown in FIGS. 8 and 9, the step bracket 2 includes a first side wall 22, a second side wall 23, and a connecting portion 24. The first side wall 22 and the second side wall 23 are planar and arranged in parallel and spaced apart. The connecting portion 24 is connected between the outer end of the first side wall 22 and the outer end of the second side wall 23, forming a step bracket slot 21 that opens inward. The step bracket 2 has a first side 201 and a second side 202 that are oriented away from each other in the width direction of the step bracket slot 21, and at least one of the first side 201 and the second side 202 has a bracket mating portion 25 that is connectable with the step 200.

It should be noted that the inner end of the step bracket slot 21 refers to the end of the step bracket slot 21 close to the vehicle 2000, while the outer end of the step bracket slot 21 refers to the end of the step bracket slot 21 away from the vehicle 2000.

According to example embodiments of the step bracket 2 for installation of the step 200, since at least one of the first side 201 and the second side 202 has a bracket mating portion 25 that is connectable with the step 200, the step 200 and the step bracket 2 are arranged side by side in the length direction of the step 200 when the step 200 is connected to the step bracket 2, which reduces the overall thickness of the assembled step bracket 2 and step 200 in the up-down direction, thereby minimizing the required space for installation. The step bracket 2 is particularly suitable for vehicles with a low chassis. Therefore, the step bracket 2 for installation of the step 200 occupies less space, has strong adaptability, and improves the vehicle's passability.

The step bracket 2 has a generally U-shaped structure and the opening of the step bracket slot 21 faces inward of the step bracket 2, which therefore provides clearance space for the first support arm 3 and the second support arm 4 of the step mounting assembly 100. In the retracted position, the step bracket 2 and the step 200 can be positioned closer to the underside of the vehicle body, reducing the likelihood of collision with obstacles and enhancing the vehicle's passability.

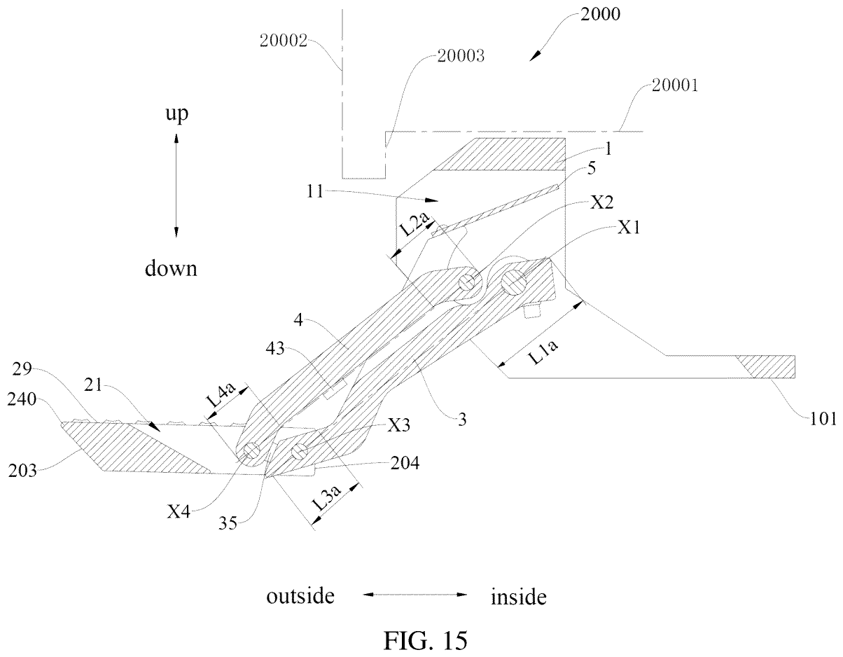

Optionally, as shown in FIGS. 8 and 9, the outer surface (also referred to as the outer surface of the step bracket) 203 of the connecting portion 24 is an inclined plane that slopes inward along the direction from top to bottom. In other words, the cross section of the connecting portion 24 is generally triangular, which reduces the likelihood of the connecting portion 24 colliding with external obstacles. As shown in FIGS. 9 and 15, the inner surface 204 of the step bracket 2 is generally a vertical face, therefore facilitating the manufacturing process of the step bracket 2.

As shown in FIGS. 8 and 9, the inner surface 28 of the connecting portion 24 is also an inclined plane that slopes inward along the direction from top to bottom. The inner surface 28 of the connecting portion 24 is the surface that defines the step bracket slot 21, and since the inner surface 28 of the connecting portion 24 is the inclined plane, clearance space is therefore provided for the first support arm 3 and the second support arm 4 of the step mounting assembly 100. In the retracted position, the step bracket 2 and the step 200 can be positioned closer to the underside of the vehicle body, reducing the likelihood of collision of the step bracket 2 and the step 200 with protruding obstacles on the ground and enhancing the vehicle's passability. For example, the inner surface 28 is inclined and can minimize the impact on the structural strength of the step bracket 2.

In some embodiments, as shown in FIGS. 8 and 9, a first boss 26 is provided on the first side wall surface 211 of the step bracket slot 21, and a second boss 27 is provided on the second side wall surface 212 of the step bracket slot 21. The first boss 26 and the second boss 27 are positioned opposite each other in the transverse direction of the step bracket 2 (i.e., the length direction of the step 200), and the outer ends of the first boss 26 and the second boss 27 are connected to the connecting portion 24. The first boss 26 can be integrally formed with the first side wall 22 and the connecting portion 24, and the second boss 27 can be integrally formed with the second side wall 23 and the connecting portion 24. In other words, the step bracket 2 is an integral structure, which enhances its overall structural strength and load-bearing capacity. Compared to the related art where the step bracket 2 is thickened in the up-down direction and its length is increased, the step bracket 2 in accordance with some embodiments of the present technology is thinner and farther from the ground in the retracted position.

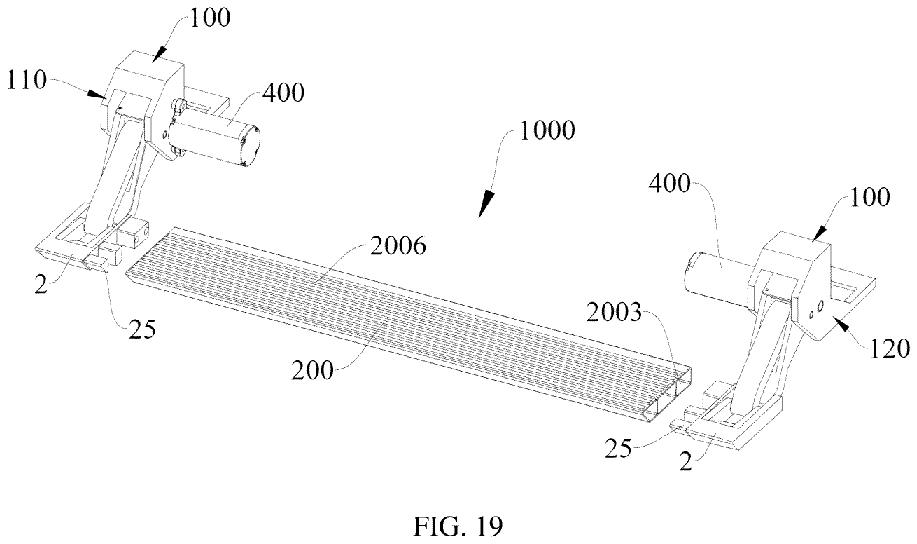

In some example embodiments, as shown in FIGS. 19 to 21, only one side of the step bracket 2 (e.g., either the first side 201 or the second side 202) is used for connection with the step 200. Specifically, there are two step mounting assemblies 100 and one step 200, and the step 200 is positioned between the two step mounting assemblies 100. One end of the step 200 in its length direction is connected to the first side 201 of the step bracket 2 of one step mounting assembly 100, while the other end of the step 200 in its length direction is connected to the second side 202 of the step bracket 2 of the other step mounting assembly 100.

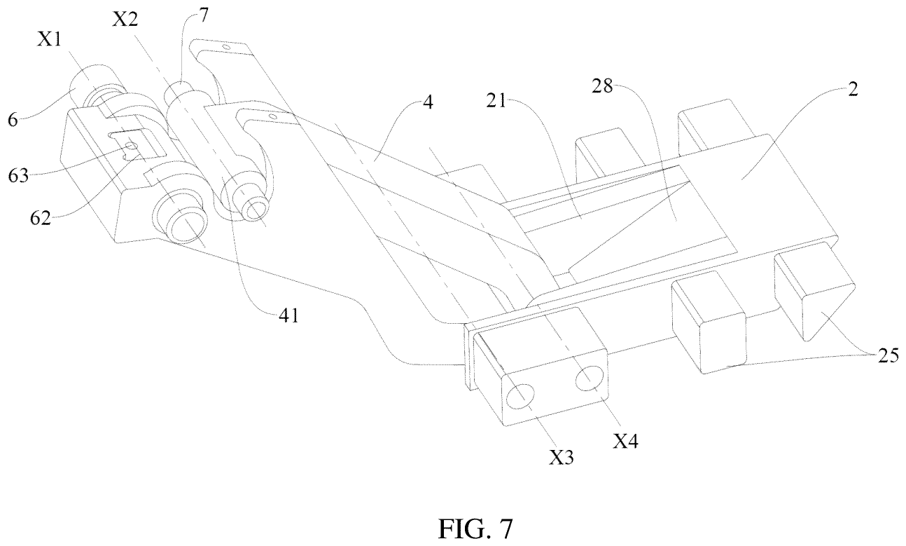

In other embodiments, as shown in FIGS. 7, 17, and 18, the first side 201 and the second side 202 of the step bracket 2 are each connected to different steps 200. Specifically, there are three step mounting assemblies 100 and two steps 200, and the three step mounting assemblies 100 and two steps 200 are alternately arranged in the length direction of the steps 200. The first side 201 and the second side 202 of the step bracket 2 of the step mounting assembly 100 located in the middle position are each connected to one of the two steps 200, allowing the retractable step device 1000 to adapt to vehicles 2000 with different wheelbases, expanding its range of application.

Optionally, at least one of the first side 201 and the second side 202 has a bracket mating portion 25 for connection with the step 200. It can be understood that the bracket mating portion 25 may be used to connect with the step mating portion 2003 of the step 200, and the step mating portion 2003 is engaged with the bracket mating portion 25 to secure the step bracket 2 and the step 200. For example, the engagement between the step mating portion 2003 and the bracket mating portion 25 can be achieved through a plug-in connection.

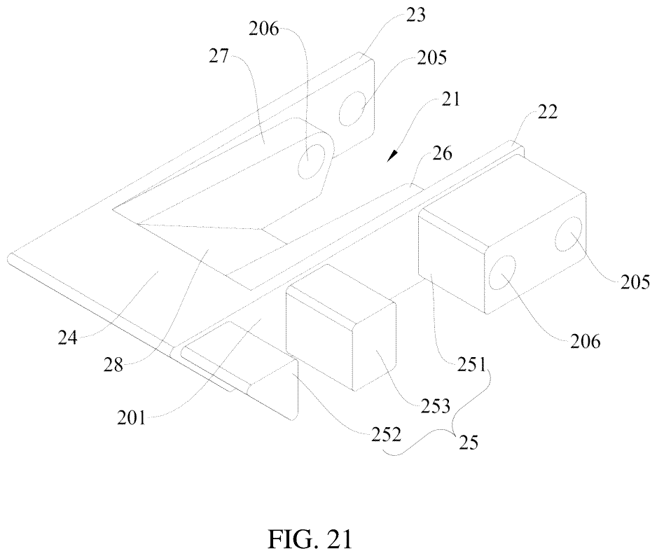

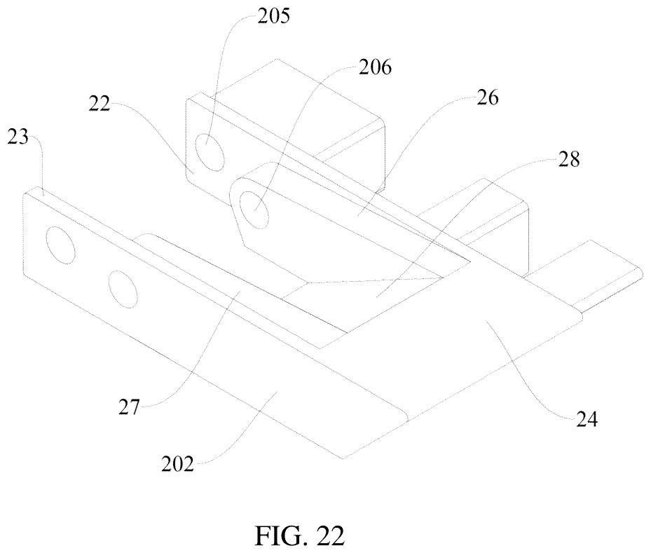

For example, as shown in FIGS. 21 and 22, the bracket mating portion 25 is provided at one side of the step bracket 2 in the transverse direction of the step bracket 2. For example, as shown in FIGS. 8 and 9, two sides of the step bracket 2 along the transverse direction of the step bracket 2 each have a bracket mating portion 25, i.e., both the first side 201 and the second side 202 have a bracket mating portion 25. Arranging the bracket mating portion 25 facilitates the connection between the step bracket 2 and the step 200, enhancing the structural stability.

Specifically, as shown in FIG. 8, the bracket mating portion 25 may include a plurality of prisms, which are spaced apart in the longitudinal direction of the step bracket 2. It can be understood that the longitudinal direction of the step bracket 2 is consistent with the width direction of the step 200, i.e., the inside-outside direction in FIG. 4. The plurality of prisms are respectively inserted into a plurality of step mating portions 2003 of the step 200, further enhancing the structural stability.

In the illustrated embodiments, the step mating portion 2003 of the step 200 is a mating hole, and the mating hole is located on an end face of the step 200 in the length direction of the step 200. The number of mating holes corresponds to the number of prisms, and the mating holes and the prisms are fitted together in a one-to-one correspondence (e.g., one inserted in the other in some embodiments).

For example, the step 200 may be a hollow aluminum alloy profile or other types of profiles. The step mating portion 2003 may be directly formed in the step 200 during a manufacturing process. The cross section of the prism matches the cross section of the step mating portion 2003 (such as the mating hole).

Illustratively, at least one prism has a non-circular cross section. For example, the prism can be a rectangular prism or a triangular prism, which prevents relative rotation between the step bracket 2 and the step 200. For example, there can be three prisms, which are spaced apart in the longitudinal direction of the step bracket 2 (i.e., the inside-outside direction).

Specifically, as shown in FIG. 8, the plurality of prisms include a first prism 251, a second prism 252, and a third prism 253, which are spaced apart in the inside-outside direction. The third prism 253 is located between the first prism 251 and the second prism 252, and the second prism 252 corresponds to the connecting portion 24 in the width direction of the step bracket slot 21. It can be understood that the second prism 252 is located at the outer side of the first prism 251 and is connected to the connecting portion 24, thereby enhancing the overall structural strength of the step bracket 2.

In some embodiments of the present technology, the first prism 251 and the third prism 253 both have a rectangular cross section and the second prism 252 has a triangular cross section, which further enhances the structural strength.

In an example, as shown in FIG. 4, the step mounting assembly 100 also includes an end cap 300, which has an end cap mating portion 3001. Both the first side 201 and the second side 202 have bracket mating portions 25. The end cap mating portion 3001 is engaged with the bracket mating portion 25 on one of the first side 201 and the second side 202 to connect the end cap 300 to the step bracket 2. It can be understood that the bracket mating portion 25 on one of the first side 201 and the second side 202 is suitable for connection with the step 200, while the bracket mating portion 25 on the other one of the first side 201 and the second side 202 is suitable for connection with the end cap 300.

By inclusion of the end cap 300, e.g., with both the first side 201 and the second side 202 of the step bracket 2 having bracket mating portions 25, one side of the step bracket 2 that is not connected to the step 200 may be connected to the end cap 300, which enhances the versatility of the step mounting assembly 100, reduces the number of production molds, and lowers manufacturing costs.

In other words, when the bracket mating portion 25 of the first side 201 of the step bracket 2 is connected, the end cap 300 may be provided at the second side 202 of the bracket mating portion 25. Similarly, when the bracket mating portion 25 of the second side 202 of the step bracket 2 is connected, the end cap 300 may be provided at the first side 201 of the bracket mating portion 25. Therefore, the step brackets 2 of the step mounting assemblies 100 in different positions are interchangeable and share the same set of molds, thereby reducing production and assembly costs.

As shown in FIG. 4, the outer peripheral profile of the end face of the end cap 300 (i.e., the surface of the end cap 300 facing the step bracket 2) is substantially flush with the outer peripheral profile of the side surface of the step bracket 2, thus no step structure is formed between the assembled end cap 300 and the step bracket 2, which, on the one hand, enhances the aesthetic appearance and overall integrity of the step mounting assembly 100, and, on the other hand, allows a part of the end cap 300 to be stepped on by users, thereby improving the space utilization of the step mounting assembly 100 and resulting in a more compact structural design.

Furthermore, the outer peripheral profile of the cross section of the step 200 is substantially aligned with the outer peripheral profile of the side surface of the step bracket 2, which enhances the overall integrity when the step 200 and the step bracket 2 are connected to each other.

In another example, as shown in FIGS. 19 to 21, the step mounting assembly 100 includes an end cap 300. One of the first side 201 and the second side 202 has a bracket mating portion 25, and the end cap 300 is connected to the other one of the first side 201 and the second side 202 or is integrally formed with the step bracket 2. It can be understood that the bracket mating portion 25 is only provided at one side of the step bracket 2 in its transverse direction for connection with the step 200. The other side of the step bracket 2 in its transverse direction is connected to the end cap 300. The end cap 300 may be connected to the step bracket 2 in a detachable manner, or may be integrally formed with the step bracket 2.

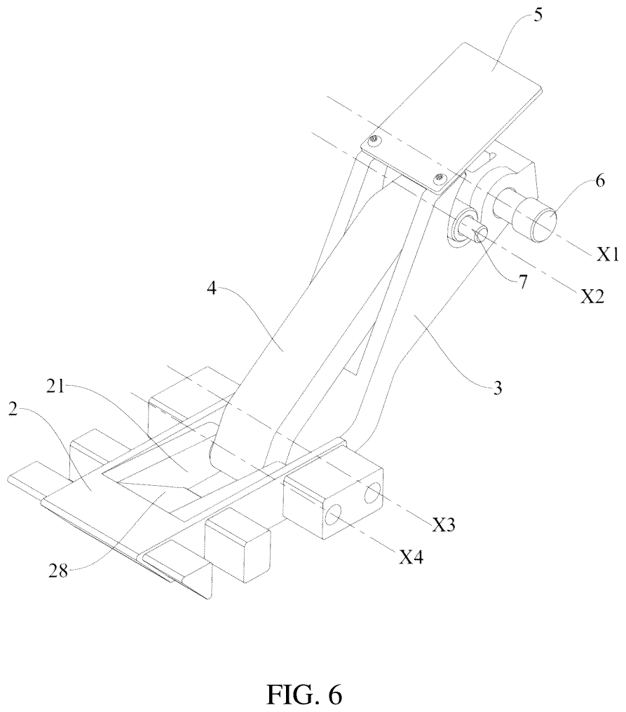

In some embodiments, as shown in FIGS. 6 to 9, the step bracket 2 is generally U-shaped and has a step bracket slot 21. The step bracket 2 includes a first side wall 22 of the step bracket, a second side wall 23 of the step bracket, and a connecting portion 24. The step bracket slot 21 opens inward. In other words, the step bracket 2 is a U-shaped plate with a step bracket slot 21 that opens inward, and the step bracket 2 has a flat structure, further reducing the occupied space.

The first support arm 3 has a first end 301 (i.e., its upper end in FIG. 13) and a second end 302 (i.e., its lower end in FIG. 13) along a length direction of the first support arm 3. The second support arm 4 has a first end 41 (i.e., its upper end in FIG. 13) and a second end 42 (i.e., its lower end in FIG. 13) along a length direction of the second support arm 4. The second end 302 of the first support arm 3 and the second end 42 of the second support arm 4 each are pivotally connected to the step bracket 2 within the step bracket slot 21, and the step bracket slot 21 can provide a clearance space for the rotation of the first support arm 3 and the second support arm 4.

Compared to the solution that “a pivot point of the support arm and the step bracket is located on the upper side, lower side, or front side of the step bracket 2,” the step mounting assembly 100 in some embodiments of the present technology may reduce the occupied space at both the extended position and the retracted position, thus improving the structural compactness.

As shown in FIG. 13, the third pivot axis X3 of the second end 302 of the first support arm 3 is located at an inner side of the fourth pivot axis X4 of the second end 42 of the second support arm 4, that is, the first support arm 3 is closer to the inner side compared to the second support arm 4.

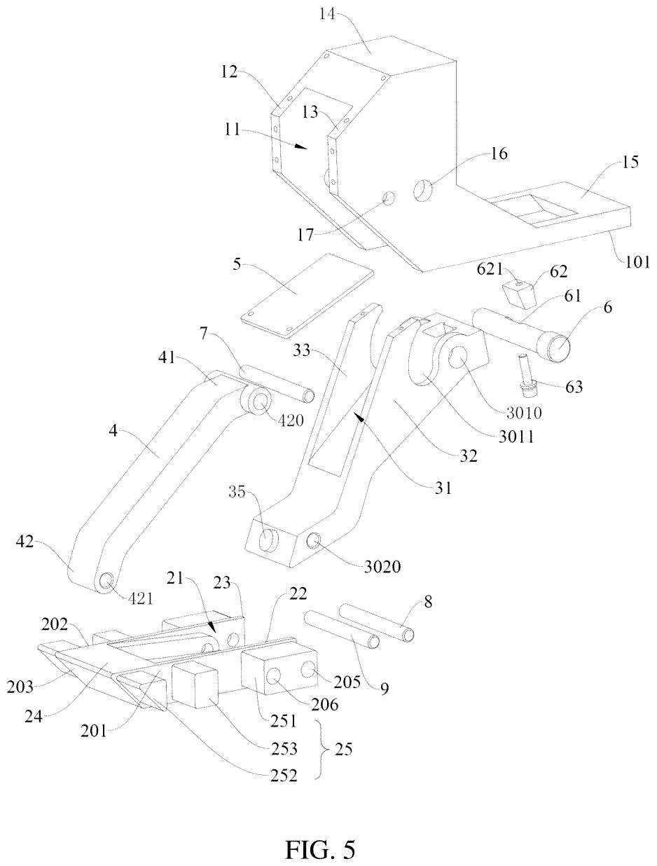

In some embodiments, as shown in FIGS. 5 to 8, the third pivot axis X3 of the second end 302 of the first support arm 3 is located at the inner sides of the first boss 26 and the second boss 27 and passes through the first side wall 22 and the second side wall 23 of the step bracket 2. In other words, the third pivot axis X3 does not pass through the first boss 26 and the second boss 27.

As shown in FIGS. 5 to 8, the fourth pivot axis X4 of the second end 42 of the second support arm 4 passes through the first side wall 22, the first boss 26, the second boss 27, and the second side wall 23 of the step bracket 2. It can be understood that the third pivot axis X3 and the fourth pivot axis X4 are generally located in the same horizontal plane, and the second end 42 of the second support arm 4 is arranged between the first boss 26 and the second boss 27.

Optionally, as shown in FIG. 8, the step bracket 2 has a third hole 205 and a fourth hole 206. The third hole 205 passes through the first side wall 22 and the second side wall 23 of the step bracket 2. Specifically, as shown in FIGS. 4 and 5, the third hole 205 is used to accommodate the third shaft 8, and a center axis of the third shaft 8 coincides with the third pivot axis X3. The second end 302 of the first support arm 3 is connected to the third shaft 8. The second end 302 of the first support arm 3 has a sixth hole 3020, and the third shaft 8 passes through the sixth hole 3020 and the third hole 205 of the step bracket 2, so that the second end 302 of the first support arm 3 is rotatable relative to the step bracket 2.

As shown in FIG. 8, the fourth hole 206 passes through the first side wall 22, the first boss 26, the second boss 27, and the second side wall 23. The third hole 205 is located at the inner side of the fourth hole 206. As shown in FIGS. 4 and 5, the fourth hole 206 is used to accommodate the fourth shaft 9, and the center axis of the fourth shaft 9 coincides with the fourth pivot axis X4. The second end 42 of the second support arm 4 has an eighth hole 421, and the fourth shaft 9 passes through the eighth hole 421 of the second support arm 4 and the fourth hole 206 of the step bracket 2, so that the second end 42 of the second support arm 4 is rotatable relative to the step bracket 2.

As shown in FIGS. 6 to 8, the inner surface 28 of the connecting portion 24 is a sloping surface, which provides avoidance for the second support arm 4 at the retracted position, thereby reducing sizes of the step bracket 2 and the second support arm 4 in the up-down direction at the retracted position.

In some embodiments, as shown in FIG. 13, in the extended position, the length of the first support arm 3 located within the step bracket slot 21 is L3a. As shown in FIG. 14, in the retracted position, the length of the first support arm 3 located within the step bracket slot 21 is L3b, where L3a is less than L3b. In other words, the size of the first support arm 3 located within the step bracket slot 21 in the retracted position is greater than the size of the first support arm 3 located within the step bracket slot 21 in the extended position.

In the extended position, as shown in FIG. 13, the length of the second support arm 4 located within the step bracket slot 21 is L4a. As shown in FIG. 14, in the retracted position, the length of the second support arm 4 located within the step bracket slot 21 is L4b, where L4a is less than L4b. In other words, the size of the second support arm 4 located within the step bracket slot 21 in the retracted position is greater than the size of the second support arm 4 located within the step bracket slot 21 in the extended position.

Therefore, in the retracted position, the first support arm 3 and the second support arm 4 can make full use of the space of the step bracket slot 21. The step bracket 2 and the step 200 can be positioned higher, that is, closer to the underside of the vehicle, thereby improving the vehicle's passability.

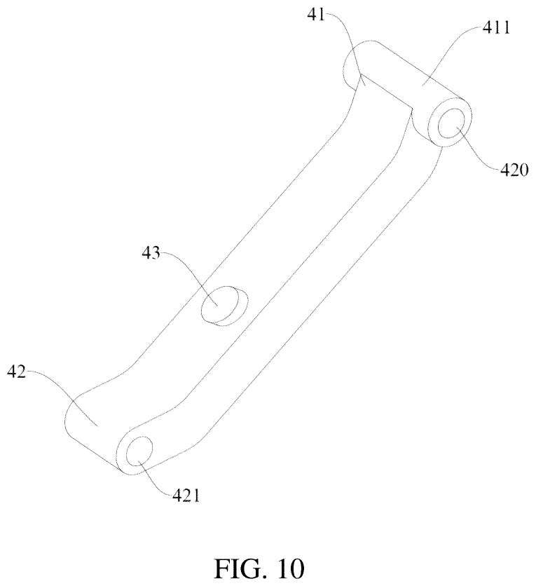

In some embodiments, as shown in FIGS. 10 to 13, the first end 301 of the first support arm 3 has an accommodating groove 3011, and the first end 41 of the second support arm 4 is accommodated within the accommodating groove 3011. Since the first end 41 of the second support arm 4 is accommodated within the accommodating groove 3011, the first pivot axis X1 of the first end 301 can be closer to the second pivot axis X2 of the first end 41, thereby making the first support arm 3 and the second support arm 4 more compact.

As shown in FIGS. 5, 10, and 11, the first end 41 of the second support arm 4 has a cylindrical portion 411 accommodated within the accommodating groove 3011. It can be understood that the cylindrical portion 411 can be rotatably accommodated within the accommodating groove 3011. When the first end 41 of the second support arm 4 rotates, the cylindrical portion 411 can synchronously rotate within the accommodating groove 3011, which can constrain the motion trajectory of the first support arm 3 and the second support arm 4, making the linkage mechanism formed by the first support arm 3, the second support arm 4, and the step bracket 2 move more smoothly.

As shown in FIGS. 5 and 10, the cylindrical portion 411 has a seventh hole 420 extending axially through the cylindrical portion 411. The seventh hole 420 accommodates the second shaft 7 connected to the vehicle 2000 or the mounting bracket 1. Illustratively, the step mounting assembly 100 includes a mounting bracket 1 having a second hole 17. The second shaft 7 is rotatably supported in the second hole 17 so that the second support arm 4 and the mounting bracket 1 are rotatably connected.

As shown in FIGS. 5, 13, and 14, the step mounting assembly 100 also includes a retaining plate 5 installed at the first end 301 of the first support arm 3 to prevent the first end 41 of the second support arm 4 from disengaging from the accommodating groove 3011. The retaining plate 5 can rotate with the rotation of the first support arm 3. The retaining plate 5 can prevent the first end 41 of the second support arm 4 from disengaging from the accommodating groove 3011 and can also cover and conceal the mating structure between the first end 41 of the second support arm 4 and the first support arm 3, which not only ensures the aesthetic appearance of the step mounting assembly 100 but also reduces the likelihood of mud and other impurities entering the accommodating groove 3011, thereby improving the reliability and stability of the rotation of the cylindrical portion 411 within the accommodating groove 3011.

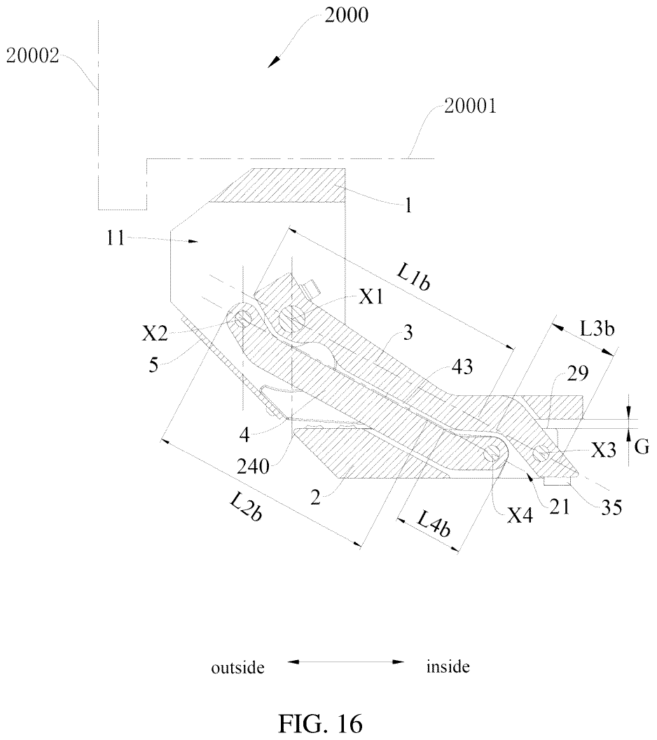

In an embodiment, as shown in FIG. 16, in the retracted position, the retaining plate 5 is positioned at the outer side of the first support arm 3 and the second support arm 4, which not only ensures the aesthetic appearance and integrity of the step mounting assembly 100 but also reduces the likelihood of mud and other impurities entering the accommodating groove 3011, thereby improving the reliability and stability of the rotation of the cylindrical portion 411 within the accommodating groove 3011.

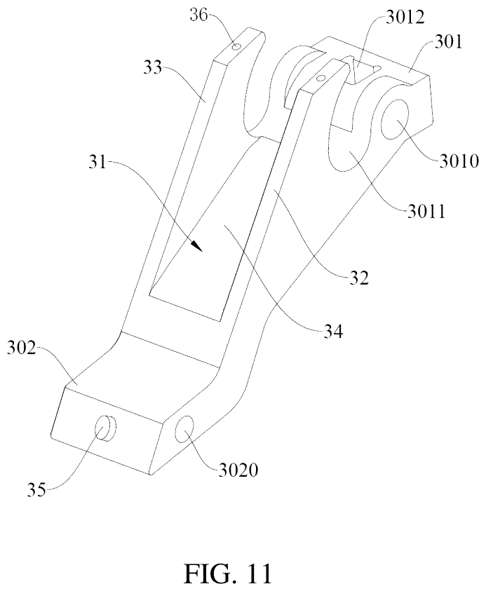

As shown in FIG. 11, the first support arm 3 has a mounting hole of retaining plate 36 used to accommodate a rivet or a screw to install the retaining plate 5.

In some embodiments, as shown in FIGS. 5 and 7, the first end 301 of the first support arm 3 has a boss mounting hole 3012 extending in the thickness direction of the first support arm 3 and a fifth hole 3010 extending in the width direction of the first support arm 3. The fifth hole 3010 passes through the boss mounting hole 3012. The fifth hole 3010 is fitted with a first shaft 6 used to drive the rotation of the first support arm 3. The boss mounting hole 3012 accommodates and is fitted with a boss 62. The first shaft 6 has a groove 61, and a part of the boss 62 is engaged with the groove 61 to prevent the first shaft 6 from rotating within the fifth hole 3010.

The boss 62 is used to restrict the rotation of the first shaft 6 relative to the fifth hole 3010. In other words, the first shaft 6 rotates together with the first support arm 3.

As shown in FIG. 5, the first shaft 6 is connected to a drive device 400 so that the drive device 400 drives the first support arm 3 to rotate through the first shaft 6. The drive device 400 can be a motor or an integrated module of a motor and a gearbox. The drive device 400 can drive the first shaft 6 to rotate, and the first shaft 6, constrained by the boss 62, drives the first support arm 3 to rotate synchronously around the axis of the first shaft 6 (i.e., the first pivot axis X1).

As shown in FIGS. 5 and 7, the groove 61 is located on the outer peripheral surface of the first shaft 6, and the boss 62 is fitted into the boss mounting hole 3012 with a part of the boss 62 embedded in the groove 61, which restricts the rotation of the first shaft 6 relative to the fifth hole 3010, that is, restricts the rotation of the first shaft 6 relative to the first support arm 3.

Illustratively, as shown in FIGS. 5 and 7, the boss 62 is connected to the first support arm 3 through a fastener 63 to prevent the boss 62 from disengaging from the boss mounting hole 3012. Boss 62 may include a hole or cavity in some embodiments. For instance, the fastener 63 can be a screw in some embodiments.

In some embodiments, as shown in FIGS. 13 and 14, the step mounting assembly 100 also includes a first buffer block 35 and a second buffer block 43. The first buffer block 35 is arranged at the first end 301 of the first support arm 3, and the second buffer block 43 is arranged at the second support arm 4. In the extended position, the first buffer block 35 faces the second support arm 4. In the retracted position, the second buffer block 43 faces the first support arm 3.

As shown in FIGS. 13 and 14, in the extended position, the first buffer block 35 can abut against the second support arm 4. In the retracted position, the second buffer block 43 abuts against the first support arm 3. This prevents direct collision between the first support arm 3 and the second support arm 4 during movement between the extended position and the retracted position, reducing noise during the operation of the step mounting assembly 100 and preventing scratching and damage to the first support arm 3 and the second support arm 4.

The first buffer block 35 and the second buffer block 43 can be made of elastic or other soft materials, such as rubber.

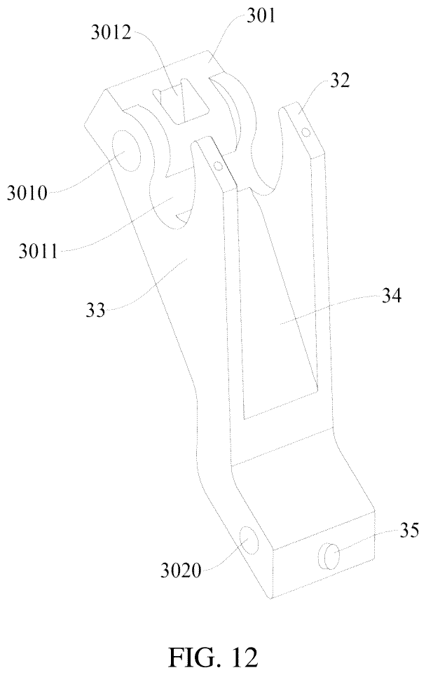

As shown in FIGS. 11 and 12, the first support arm 3 has an arm slot 31 extending along the length direction of the first support arm 3. The depth of the arm slot 31 can vary gradually along the length direction of the first support arm 3. A part of the second support arm 4 is accommodated within the arm slot 31. In a cross section orthogonal to the length direction of the first support arm 3, the cross-sectional profile of the first support arm 3 is generally U-shaped.

As shown in FIG. 11, the arm slot 31 includes a first side wall 32, a second side wall 33, and a bottom surface 34. The first side wall 32 and the second side wall 33 are arranged on two sides of the bottom surface 34 along the width direction of the first support arm 3 to form a generally U-shaped space.

Since a part of the second support arm 4 is accommodated within the arm slot 31, the step mounting assembly 100 is more compact in the retracted position. The first support arm 3 can constrain and protect the second support arm 4, which is conducive to improving the stability of the step mounting assembly's movement.

In some embodiments, as shown in FIGS. 13 to 16, the step mounting assembly 100 also includes a mounting bracket 1 that is able to be connected to the vehicle 2000. The first end 301 of the first support arm 3 is connected to the mounting bracket 1 and is pivotable around the first pivot axis X1. The second end 302 of the first support arm 3 is connected to the step bracket 2 and is pivotable around the third pivot axis X3. The first end 41 of the second support arm 4 is connected to the mounting bracket 1 and is pivotable around the second pivot axis X2. The second end 42 of the second support arm 4 is connected to the step bracket 2 and is pivotable around the fourth pivot axis X4.

As shown in FIGS. 13 and 14, the mounting bracket 1, the first support arm 3, the second support arm 4, and the step bracket 2 form a linkage mechanism. When the drive device 400 drives the first support arm 3 to rotate around the first pivot axis X1, the second support arm 4, as a driven rod, rotates synchronously, thereby driving the step bracket 2 and the step 200 connected to the step bracket 2 to extend or retract.

As shown in FIG. 14, the mounting bracket 1 can extend horizontally beyond a vehicle outer edge 20002 so that the side rail 500 can be installed on the mounting bracket 1, improving the convenience of installing the side rail 500. Optionally, as shown in FIG. 15, the mounting bracket 1 can be located at the inner side 20003 of the vehicle outer edge 20002 along the horizontal direction.

In some examples, as shown in FIGS. 13 and 14, the first pivot axis X1 is located at the inner side of the second pivot axis X2, and the third pivot axis X3 is located at the inner side of the fourth pivot axis X4.

As shown in FIG. 5, the first shaft 6 passes through the first hole 16 of the mounting bracket 1 and is connected to the first end 301 of the first support arm 3. The first pivot axis X1 coincides with the center axis of the first shaft 6.

As shown in FIG. 5, the mounting bracket 1 has a mounting bracket slot 11 extending along the length direction of the mounting bracket 1. The first end 301 of the first support arm 3 is pivotally connected to the mounting bracket 1 within the mounting bracket slot 11, and the first end 41 of the second support arm 4 is pivotally connected to the mounting bracket 1 within the mounting bracket slot 11.

In the extended position, the length of the first support arm 3 located within the mounting bracket slot 11 is L1a. In the retracted position, the length of the first support arm 3 located within the mounting bracket slot 11 is L1b, where L1a is less than L1b.

As shown in FIGS. 13 to 16, in the extended position, the length of the second support arm 4 located within the mounting bracket slot 11 is L2a. In the retracted position, the length of the second support arm 4 located within the mounting bracket slot 11 is L2b, where L2a is less than L2b.

Therefore, in the retracted position, the first support arm 3 and the second support arm 4 can make full use of the space of the mounting bracket slot 11. The step bracket 2 and the step 200 can be positioned closer to the underside of the vehicle, that is, the step bracket 2 and the step 200 can be positioned to be further (e.g. higher) up.

Optionally, as shown in FIG. 16, in the retracted position, the upper surface 29 of the step bracket 2 is close to the bottom surface 101 of the mounting bracket 1, which can further reduce the size of the step mounting assembly 100 in the retracted position, bringing the step bracket 2 and the step 200 closer to the underside of the vehicle, which is beneficial for expanding the application range of the step mounting assembly 100.

Illustratively, as shown in FIG. 16, the spacing G between the upper surface 29 of the step bracket 2 and the bottom surface 101 of the mounting bracket 1 is less than 20 millimeters. Preferably, the spacing G is greater than or equal to 1 millimeter and less than or equal to 8 millimeters. For instance, the spacing G can be 1 millimeter, 2 millimeters, 4 millimeters, 6 millimeters, or 8 millimeters.

As shown in FIG. 5, the mounting bracket 1 includes an extension portion 15 extending inward horizontally. The extension portion 15 can be connected to the underside 20001 of the vehicle 2000 to improve the reliability of the connection between the step mounting assembly 100 and the vehicle 2000.

As shown in FIG. 5, the mounting bracket 1 includes a first side wall 12, a second side wall 13, and a top wall 14. The first side wall 12 and the second side wall 13 are arranged along the transverse direction of the mounting bracket 1 (i.e., the length direction of the step 200). The top wall 14 is connected to the first side wall 12 and the second side wall 13 to form the mounting bracket slot 11.

In some embodiments, as shown in FIGS. 13 to 16, in the retracted position, in a plane orthogonal to the first pivot axis X1, that is, when viewed along the length direction of the step 200, the outer edge 240 of the step bracket 2 is located at the inner side of the second pivot axis X2. That is, when the step bracket 2 is in the retracted position, the outer edge 240 is positioned closer to the inner side and the vehicle 2000 than the second pivot axis X2, and the step bracket 2 and the step 200 are closer to the underside of the vehicle, reducing the likelihood of contact with obstacles.

Illustratively, as shown in FIG. 14, in a plane orthogonal to the first pivot axis X1, the outer edge 240 of the step bracket is located at the inner side of the first pivot axis X1. Therefore, in the retracted position, the step bracket 2 and the step 200 are positioned more inward and higher up, reducing the likelihood of contact with obstacles.

Optionally, as shown in FIG. 14, in a plane orthogonal to the first pivot axis X1, the outer edge 240 of the step bracket 2 is aligned with the first pivot axis X1 in the up-down direction. Further optionally, in a plane orthogonal to the first pivot axis X1, the outer edge 240 of the step bracket 2 is located at the outer side of the first pivot axis X1 and close to the first pivot axis X1. Preferably, the distance between the outer edge 240 of the step bracket 2 and the first pivot axis X1 is less than 5 millimeters.

As shown in FIG. 14, in a plane orthogonal to the first pivot axis X1, in the retracted position, the angle θ between the first connecting line S1 connecting the first pivot axis X1 and the third pivot axis X3 and the horizontal direction is greater than or equal to 25 degrees and less than or equal to 35 degrees. It was discovered through experimental research that when the angle θ between the first connecting line S1 and the horizontal plane is within the above range, it can reduce the height of the step mounting assembly 100 in the up-down direction after retraction while avoiding interference between the first support arm 3 and the vehicle 2000, thus improving the spatial utilization of the step mounting assembly 100 above or on the vehicle 2000 and making the structure of the step mounting assembly 100 more compact.

For example, the angle θ between the first connecting line S1 and the horizontal plane can be 25 degrees, 28 degrees, 30 degrees, 32 degrees, or 35 degrees.

Similarly, as shown in FIG. 14, in a plane orthogonal to the first pivot axis X1, in the retracted position, the angle θ between the second connecting line S2, which connects the second pivot axis X2 and the fourth pivot axis X4, and the horizontal direction is greater than or equal to 25 degrees and less than or equal to 35 degrees. It can be understood that the angle θ between the second connecting line S2 and the horizontal plane is selected within the range of 25 to 35 degrees. Through experimental research and verification, it was found that when the angle θ between the second connecting line S2 and the horizontal plane is within the above range, it can reduce the height of the step mounting assembly 100 after retraction while avoiding interference between the retracted second support arm 4 and the vehicle 2000, thus improving the spatial utilization of the step mounting assembly 100 on the vehicle 2000 and making the structure of the step mounting assembly 100 more compact.

It should be noted that the angle between the first connecting line S1 and the horizontal plane can be equal to or different from the angle between the second connecting line S2 and the horizontal plane. For example, the angle between the second connecting line S2 and the horizontal plane can be 25 degrees, 28 degrees, 30 degrees, 32 degrees, or 35 degrees.

Preferably, in the retracted position, the second connecting line S2 connecting the second pivot axis X2 and the fourth pivot axis X4 is generally parallel to the first connecting line S1.

As shown in FIGS. 14 and 15, when the step mounting assembly 100 is in the retracted position, in a direction from the first end 301 to the second end 302 of the first support arm 3, the first support arm 3 generally extends obliquely downward toward the inner side of the vehicle 2000. Similarly, in a direction from the first end 41 to the second end 42 of the second support arm 4, the second support arm 4 generally extends obliquely downward toward the inner side of the vehicle 2000. In the retracted position, the first support arm 3 is located above the second support arm 4.

As shown in FIGS. 13 and 15, when the step mounting assembly 100 is in the extended position, in the direction from the first end 301 to the second end 302 of the first support arm 3, the first support arm 3 generally extends obliquely downward toward the outer side of the vehicle 2000. Similarly, in the direction from the first end 41 to the second end 42 of the second support arm 4, the second support arm 4 generally extends obliquely downward toward the outer side of the vehicle 2000. In the extended position, the first support arm 3 is located below the second support arm 4.

When the step mounting assembly 100 moves between the retracted position and the extended position, the first support arm 3 and the second support arm 4 have a certain swing angle. In some examples, the swing angle of the first connecting line S1 from the retracted position to the extended position is greater than or equal to 105 degrees and less than or equal to 120 degrees. Since the first connecting line S1 can be generally parallel to the second connecting line S2, the swing angle of the second connecting line S2 is also greater than or equal to 105 degrees and less than or equal to 120 degrees.

Through experimental research, it was found that when the swing angle of the first connecting line S1 is within the above range before moving from the retracted position to the extended position, the action process of the step mounting assembly 100 is more coherent and the mechanical performance is better.

For example, the swing angle of the first connecting line S1 (or the swing angle of the second connecting line S2) can be 105 degrees, 110 degrees, 115 degrees, or 120 degrees.

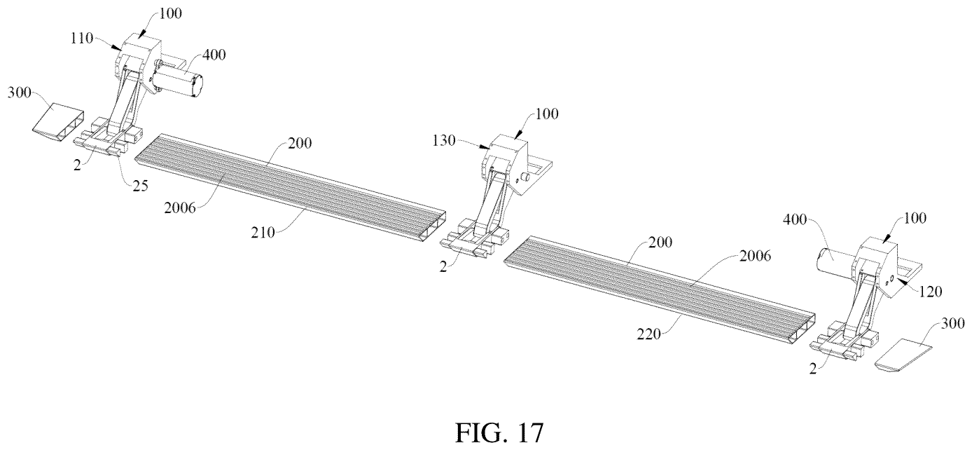

As shown in FIGS. 17 to 20, some other embodiments of the retractable step device 1000 of the present technology include at least one step 200 and a plurality of step mounting assemblies 100. The step 200 has a tread surface 2006. In the step brackets 2 of adjacent step mounting assemblies 100, a first side 201 of one step bracket 2 is opposite to a second side 202 of another step bracket 2. The step 200 is connected between the first side 201 of one step bracket 2 and the second side 202 of another step bracket 2 so that the step mounting assembly 100 moves the step 200 between the extended position and the retracted position.

According to some embodiments of the present technology, since the step 200 is connected between the first side 201 of one step bracket 2 and the second side 202 of another step bracket 2, the overall thickness of the assembled step bracket 2 and step 200 in the up-down direction is small in the extended position, and especially small in the retracted position, which requires less mounting space. The step mounting assembly 100 is particularly suitable for a vehicle 2000 with a low chassis.

In an embodiment, as shown in FIG. 19, the step mounting assembly 100 includes a first step mounting assembly 110 and a second step mounting assembly 120. The first end 2001 of the step 200 is connected to the first side 201 of the step bracket 2 of the first step mounting assembly 110, and the second end 2002 of the step 200 is connected to the second side 202 of the step bracket 2 of the second step mounting assembly 120. In this embodiment, the retractable step device 1000 includes only two step mounting assemblies 100 (i.e., the first step mounting assembly 110 and the second step mounting assembly 120), which are arranged on two sides of the step 200 along the length direction of the step 200.

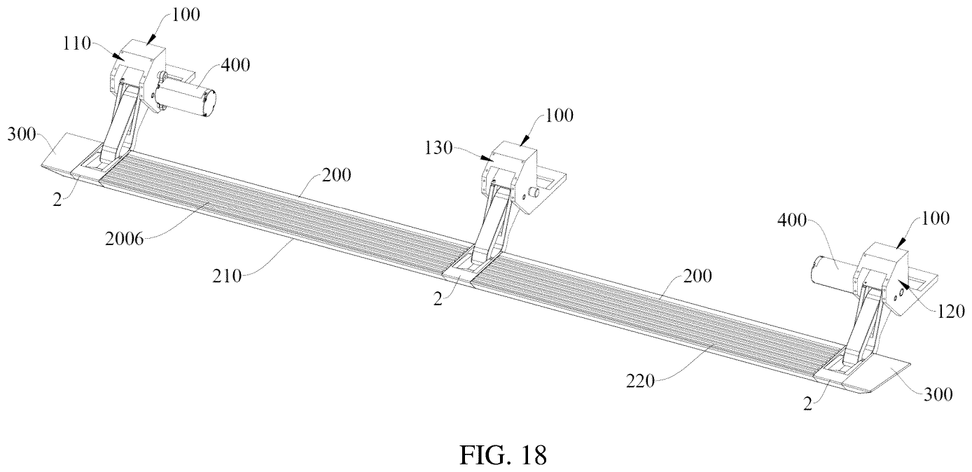

In another embodiment, as shown in FIGS. 17 and 18, the step mounting assembly 100 includes a first step mounting assembly 110, a second step mounting assembly 120, and at least one intermediate step mounting assembly 130 located between the first step mounting assembly 110 and the second step mounting assembly 120. The step 200 includes at least a first step 210 and a second step 220. The first end 2001 of the first step 210 is connected to the first side 201 of the step bracket 2 of the first step mounting assembly 110, and the second end 2002 of the first step 210 is connected to the second side 202 of the step bracket 2 of one intermediate step mounting assembly 130. The first end 2001 of the second step 220 is connected to the first side 201 of the step bracket 2 of one intermediate step mounting assembly 130 or another intermediate step mounting assembly 130, and the second end 2002 of the second step 220 is connected to the second side 202 of the step bracket 2 of the second step mounting assembly 120.

As shown in FIGS. 17 and 18, a plurality of step mounting assemblies 100 (i.e., the first step mounting assembly 110, the second step mounting assembly 120, and the intermediate step mounting assembly 130) and a plurality of steps 200 (i.e., the first step 210 and the second step 220) are alternately arranged along the length direction of the step 200. The intermediate step mounting assembly 130 is located between the first step mounting assembly 110 and the second step mounting assembly 120. The first side 201 and the second side 202 of the step bracket 2 of the intermediate step mounting assembly 130 are connected to two steps 200 (i.e., the first step 210 and the second step 220, respectively), thereby extending the length of the retractable step device 1000 and expanding its application range.

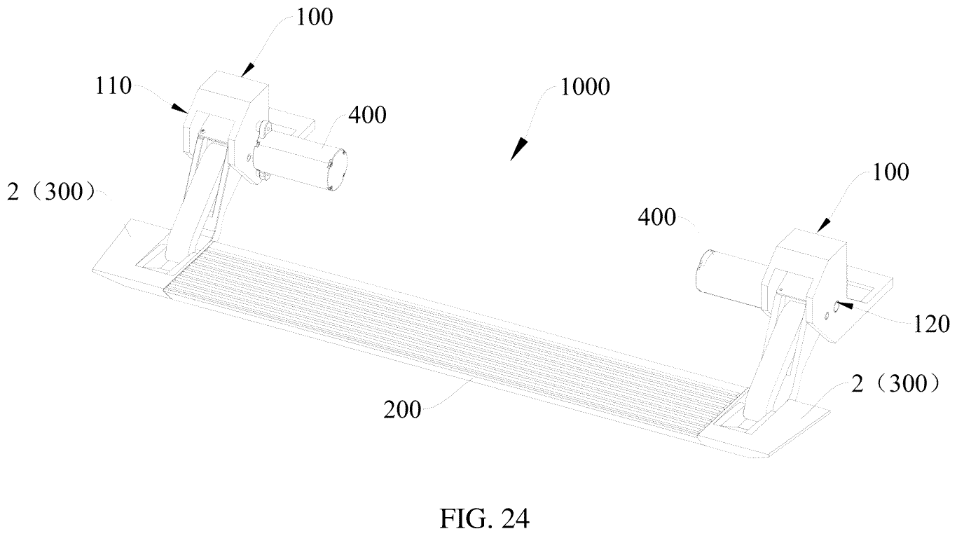

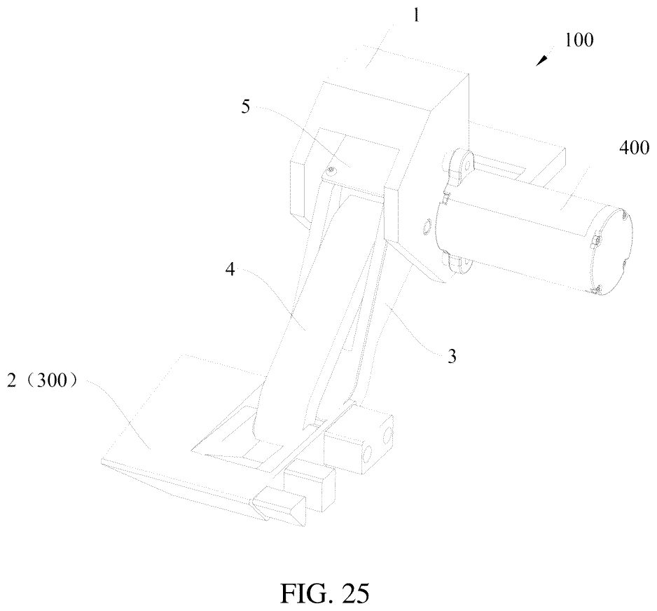

As shown in FIGS. 24 and 25, each of the first step mounting assembly 110 and the second step mounting assembly 120 includes an end cap 300. The end cap 300 of the first step mounting assembly 110 is connected to the second side 202 of the step bracket 2 of the first step mounting assembly 110, and the end cap 300 of the second step mounting assembly 120 is connected to the first side 201 of the step bracket 2 of the second step mounting assembly 120. In other words, when the bracket mating portion 25 of the first side 201 of the step bracket 2 is connected to the step 200, an end cap 300 can be provided on the bracket mating portion 25 of the second side 202 of the step bracket 2. Similarly, when the bracket mating portion 25 of the second side 202 of the step bracket 2 is connected to the step 200, an end cap 300 can be provided on the bracket mating portion 25 of the first side 201 of the step bracket 2 so that the step brackets 2 of the step mounting assemblies 100 at different positions are interchangeable, reducing costs of production and assembly.

The second side 202 of the step bracket 2 of the first step mounting assembly 110 and the first side 201 of the step bracket 2 of the second step mounting assembly 120 each have a bracket mating portion 25, respectively. The end cap 300 has an end cap mating portion 3001 engaged with the bracket mating portion 25.

Furthermore, as shown in FIGS. 17 to 19, the upper surface of the end cap 300, the tread surface 2006 of the step 200, and the upper surface 29 of the step bracket 2 are generally flush. The outer surface 3004 of the end cap, the outer surface 2007 of the step 200, and the outer surface 203 of the step bracket 2 are also generally flush. This not only improves the overall integration of the assembled step 200, the step bracket 2, and the end cap 300 but also allows users to step on the end cap 300, thereby improving the spatial utilization of the retractable step device 1000 and resulting in a more compact structural design.

Below are some other specific example embodiments of the retractable step device 1000.

As shown in FIGS. 1 to 27, the retractable step device 1000 in accordance with some example embodiments of the present technology includes a step 200 and a plurality of step mounting assemblies 100. The step 200 has a first end 2001 and a second end 2002 along its length direction and a tread surface 2006. The step 200 is connected between adjacent step mounting assemblies 100.

The step mounting assembly 100 includes a mounting bracket 1, a step bracket 2, and at least one pair of support arms (e.g., the first support arm 3 and the second support arm 4). The step bracket 2 has a step bracket slot 21 that opens inward and has a first side 201 and a second side 202 oriented away from each other along the length direction of the step 200. The at least one pair of support arms are pivotally connected to the mounting bracket 1 and the step bracket 2 to move the step 200 between the extended position and the retracted position.

In two adjacent step mounting assemblies 100, the first side 201 of the step bracket 2 of one step mounting assembly 100 faces the second side 202 of the step bracket 2 of the another step mounting assembly 100 along the length direction of the step 200. The first end 2001 of the step 200 is connected to the first side 201 of the step bracket 2 of one step mounting assembly 100, and the second end 2002 of the step 200 is connected to the second side 202 of the step bracket 2 of the another step mounting assembly 100.

In other words, two adjacent step mounting assemblies 100 are arranged at two sides of the step 200 along the length direction of the step 200. This allows for simple assembly of the retractable step device 1000. In the extended position, and especially in the retracted position, the overall thickness of the step bracket 2 and the step 200 when assembled is small, requiring less mounting space so that the step mounting assembly 100 may be better applied to (e.g., installed on) a vehicle 2000 with a low chassis.

As shown in FIGS. 13 to 16, in the extended position, the length of the first support arm 3 located within the step bracket slot 21 is L3a, and the length of the second support arm 4 located within the step bracket slot 21 is L4a. In the retracted position, the length of the first support arm 3 located within the step bracket slot 21 is L3b, and the length of the second support arm 4 located within the step bracket slot 21 is L4b, where L3a is less than L3b and L4a is less than L4b. In the retracted position, the tread surface 2006 of the step 200 is generally horizontal and close to the bottom surface 101 of the mounting bracket 1.

As shown in FIG. 14, in the retracted position, the length of the second support arm 4 located within the step bracket slot 21 is L4b, where L4a is less than L4b.

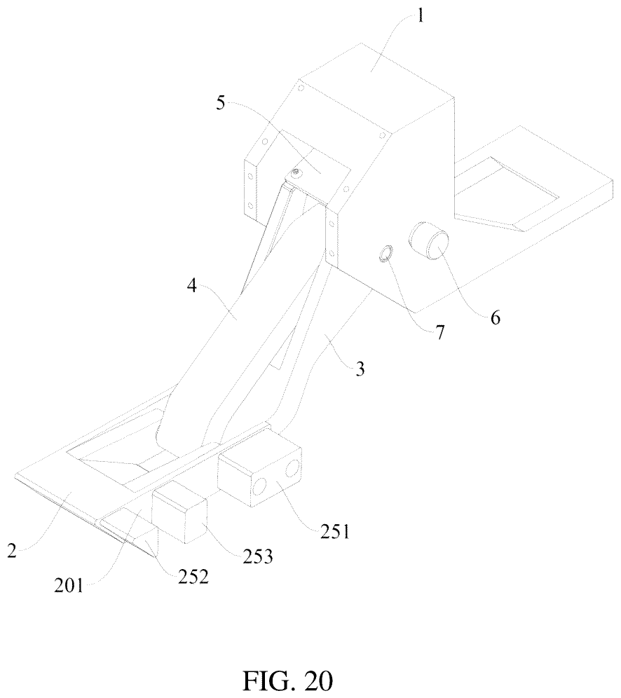

Optionally, as shown in FIGS. 19 and 20, the first end 2001 and the second end 2002 of the step 200 each have a step mating portion 2003. The first side 201 of the step bracket 2 of one step mounting assembly 100 and the second side 202 of the step bracket 2 of another step mounting assembly 100 each have a bracket mating portion 25. The step mating portion 2003 is engaged with the bracket mating portion 25.

Optionally, one of the step mating portion 2003 and the bracket mating portion 25 includes at least one mating hole, and another of the step mating portion 2003 and the bracket mating portion 25 includes at least one prism. The cross section of the mating hole and the cross section of the prism are non-circular and complementary to each other, with the prism inserted and fitted within the mating hole. This enhances the overall structural strength of the step bracket 2, making the connection between the step bracket 2 and the step 200 more reliable and facilitating easy disassembly and assembly.

In some embodiments, as shown in FIG. 16, the first end 301 of the first support arm 3 is pivotable relative to the mounting bracket 1 around the first pivot axis X1, and the second end 302 of the first support arm 3 is pivotable relative to the step bracket 2 around the third pivot axis X3. The first end 41 of the second support arm 4 is pivotable relative to the mounting bracket 1 around the second pivot axis X2, and the second end 42 of the second support arm 4 is pivotable relative to the step bracket 2 around the fourth pivot axis X4. In a plane orthogonal to the length direction of the step 200, in the retracted position, the third pivot axis X3 and the fourth pivot axis X4 are located within the region defined by the outer profile of the step 200, and the outer edge 2004 of the step 200 is located at the inner side of the second pivot axis X2.

As shown in FIGS. 14 and 16, when the step 200 is in the retracted position, the outer edge 2004 of the step 200 is located at an inner position relative to the second pivot axis X2. Since the third pivot axis X3 and the fourth pivot axis X4 are located within the region defined by the outer profile of the step 200, the retractable step device 1000 can have a more compact structure and occupy less space.

Optionally, as shown in FIGS. 14 and 16, in a plane orthogonal to the length direction of the step 200 (i.e., in a plane orthogonal to the first pivot axis X1), in the retracted position, the outer edge 2004 of the step 200 is located at the inner side of the first pivot axis X1. Alternatively, in a plane orthogonal to the length direction of the step 200, in the retracted position, the outer edge 2004 of the step 200 is located at the outer side of the first pivot axis X1 but close to the first pivot axis X1. In other words, when the step 200 is in the retracted position, the outer edge 2004 of the step 200 is generally located between the first pivot axis X1 and the second pivot axis X2. Preferably, the distance between the outer edge 2004 of the step 200 and the first pivot axis X1 is less than 5 millimeters.

Below are some other specific example embodiments of the retractable step device 1000.

As shown in FIGS. 1 to 27, the retractable step device 1000 in accordance with some embodiments of the present technology includes a step 200, a first support arm 3, and a second support arm 4. The step 200 has a tread surface 2006 and is movable between an extended position and a retracted position. The first support arm 3 is connected to the underside 20001 of the vehicle 2000 and is pivotable around the first pivot axis X1. The first support arm 3 is connected to the step 200 and is pivotable around the third pivot axis X3. The second support arm 4 is connected to the underside 20001 of the vehicle 2000 and is pivotable around the second pivot axis X2. The second support arm 4 is connected to the step 200 and is pivotable around the fourth pivot axis X4. In a plane orthogonal to the first pivot axis X1, in the retracted position, the third pivot axis X3 and the fourth pivot axis X4 are located within the region defined by the outer profile of the step 200.

In some embodiments of the retractable step device 1000, in the retracted position, the third pivot axis X3 and the fourth pivot axis X4 are located within the region defined by the outer profile of the step 200. The retractable step device 1000 is farther from the ground, requiring less mounting space for the retractable step device 1000 and improving the vehicle's passability.

Optionally, as shown in FIGS. 13 and 14, in a plane orthogonal to the first pivot axis X1, in the retracted position, the third pivot axis X3 is close to an inner edge 2005 of the step 200. This makes the structure of the retractable device more compact and reduces the height dimension in the retracted position.

As shown in FIGS. 4 to 7, the first end 301 of the first support arm 3 is pivotable around the first pivot axis X1, and the second end 302 of the first support arm 3 is pivotable around the third pivot axis X3. The first end 41 of the second support arm 4 is pivotable around the second pivot axis X2, and the second end 42 of the second support arm 4 is pivotable around the fourth pivot axis X4.

The first end 301 of the first support arm 3 has an accommodating groove 3011, and the first end 41 of the second support arm 4 is accommodated within the accommodating groove 3011. This allows the first pivot axis X1 of the first end 301 of the first support arm 3 to be closer to the second pivot axis X2 of the first end 41 of the second support arm 4, making the structure of the first support arm 3 and the second support arm 4 more compact.

In a direction parallel to the first pivot axis X1, the step 200 is arranged side by side with the first support arm 3 and the second support arm 4, such that the projection of the step 200 in the horizontal plane does not overlap with the projections of the first support arm 3 and the second support arm 4 in the horizontal plane, which reduces the overall thickness of the retractable step device 1000 in the retracted position.

By arranging the projection of the step 200 in the horizontal plane not overlapping with the projection of the first support arm 3 and the second support arm 4 in the horizontal plane so that the pivot structure of the first support arm 3 (or the second support arm 4) and the step 200 is at approximately the same horizontal height as the step 200, in the retracted position, the overall thickness of the retractable step device 1000 is reduced.

Below are some other specific example embodiments of the retractable step device 1000.

As shown in FIGS. 1 to 27, the retractable step device 1000 in accordance with some embodiments of the present technology includes a step 200, a first support arm 3, and a second support arm 4. The step 200 has a tread surface 2006 and is movable between an extended position and a retracted position. The first support arm 3 is connected to the underside 20001 of the vehicle 2000 and is pivotable around the first pivot axis X1. The first support arm 3 is connected to the step 200 and is pivotable around the third pivot axis X3. The second support arm 4 is connected to the underside 20001 of the vehicle 2000 and is pivotable around the second pivot axis X2. The second support arm 4 is connected to the step 200 and is pivotable around the fourth pivot axis X4.

The second pivot axis X2 is located at the outer side of the first pivot axis X1, and the fourth pivot axis X4 is located at the outer side of the third pivot axis X3. In a plane orthogonal to the first pivot axis X1, in the retracted position, the outer edge 2004 of the step 200 is located at the inner side of the second pivot axis X2.

In some embodiments of the retractable step device 1000, for example, since, in a plane orthogonal to the first pivot axis X1, the outer edge 2004 of the step 200 is located at the inner side of the second pivot axis X2 in the retracted position of the step 200, the first support arm 3 and the second support arm 4 are more compactly stacked in the retracted position. This not only reduces the size of the retractable step device 1000 along the inside-outside direction but also allows the step 200 to be positioned higher in the retracted position and farther from the ground.

Optionally, in a plane orthogonal to the first pivot axis X1, in the retracted position, the outer edge 2004 of the step 200 is located at the inner side of the first pivot axis X1.

In a plane orthogonal to the first pivot axis X1, in the retracted position, the outer edge 2004 of the step 200 is located at the outer side of the first pivot axis X1 but close to the first pivot axis X1. Preferably, the distance between the outer edge 2004 of the step 200 and the first pivot axis X1 is less than 5 millimeters.

Furthermore, as shown in FIG. 19, the retractable step device 1000 also includes a step bracket 2. The second end 302 of the first support arm 3 is pivotally connected to the step bracket 2, and the second end 42 of the second support arm 4 is pivotally connected to the step bracket 2. The step 200 is arranged side by side with the step bracket 2 in the length direction of the step 200, such that the projection of the step 200 in the horizontal plane does not overlap with the projection of the step bracket 2 in the horizontal plane.

The step bracket 2 and the step 200 are generally at the same horizontal height. This not only reduces the overall thickness of the step bracket 2 and step 200 when assembled but also allows a part of the step bracket 2 to be stepped on by users so that the structure of the retractable step device 1000 is more compact, improving spatial utilization and providing better usability.

The technical features described in the above specific example embodiments can be implemented in various configurations. Some examples of these configurations are discussed below.

In some configurations, for example, a retractable step device includes: a step having a first end and a second end along a length direction of the step, and a tread surface; a plurality of step mounting assemblies, with the step connected between adjacent step mounting assemblies, wherein each step mounting assembly includes: a mounting bracket; a step bracket having a step bracket slot that opens inward and having a first side and a second side oriented away from each other along the length direction of the step; at least one pair of support arms pivotally connected to the mounting bracket and the step bracket to move the step between an extended position and a retracted position; wherein, in two adjacent step mounting assemblies, a first side of the step bracket of one step mounting assembly faces a second side of the step bracket of the another step mounting assembly along the length direction of the step, a first end of the step is connected to the first side of the step bracket of one step mounting assembly, and a second end of the step is connected to the second side of the step bracket of the another step mounting assembly; wherein, in the extended position, a length of the first support arm of the at least one pair of support arms located within the step bracket slot is L3a, and the length of the second support arm of the at least one pair of support arms located within the step bracket slot is L4a; in the retracted position, a length of the first support arm located within the step bracket slot is L3b, and a length of the second support arm located within the step bracket slot is L4b, where L3a is less than L3b and L4a is less than L4b; and in the retracted position, the tread surface of the step is generally horizontal and close to the bottom surface of the mounting bracket.

In some configurations, for example, a vehicle apparatus includes a vehicle, a side rail installed on the vehicle, and a retractable step device installed on an underside of the vehicle, wherein the retractable step device can be the retractable step device described in the above configurations; in the retracted position, the step is located below an inner side of the side rail; and in the extended position, the step is located below the side rail and is at least partially located at an outer side of the side rail.

In some configurations, for example, a retractable step device includes: a step having a tread surface and being movable between an extended position and a retracted position; a first support arm connected to an underside of a vehicle and pivotable around a first pivot axis, with the first support arm connected to the step and pivotable around a third pivot axis; a second support arm connected to the underside of the vehicle and pivotable around a second pivot axis, with the second support arm connected to the step and pivotable around a fourth pivot axis; wherein, in a plane orthogonal to the first pivot axis, in the retracted position, the third pivot axis and the fourth pivot axis are located within a region defined by an outer profile of the step.

In some configurations, for example, a retractable step device includes: a step having a tread surface and being movable between an extended position and a retracted position; a first support arm connected to an underside of a vehicle and pivotable around a first pivot axis, with the first support arm connected to the step and pivotable around a third pivot axis; a second support arm connected to the underside of the vehicle and pivotable around a second pivot axis, with the second support arm connected to the step and pivotable around a fourth pivot axis; wherein the second pivot axis is located at an outer side of the first pivot axis, and the fourth pivot axis is located at an outer side of the third pivot axis; in a plane orthogonal to the first pivot axis, in the retracted position, the outer edge of the step is located at an inner side of the second pivot axis.

In some configurations, for example, a step bracket configured to install a step includes: a first side wall, a second side wall, and a connecting portion, wherein the first side wall and the second side wall each have a plate-like shape and are arranged parallel and spaced apart from each other. The connecting portion is connected between an outer end of the first side wall and an outer end of the second side wall to enclose a step bracket slot that opens inward. The step bracket has a first side and a second side oriented away from each other in a width direction of the step bracket slot, and at least one of the first side and the second side has a bracket mating portion configured to be connected to the step.

### Conclusion

In the description of the present disclosure, it should be understood that the orientation or positional relationship indicated by the terms “length,” “width,” “thickness,” “up,” “down,” “front,” “rear,” “left,” “right,” “vertical,” “horizontal,” “top,” “bottom,” “inside,” “outside,” “axial,” “radial,” “circumferential,” and the like is based on the orientation or positional relationship shown in the attached drawings, which is only for the convenience of describing the present technology and simplifying the description, and does not indicate or imply that the referred device or element must have a specific orientation and be constructed and operated in a specific orientation, so it cannot be understood as a limitation of the present technology.

In addition, the terms “first” and “second” are used only for the purpose of distinguishing, and cannot be understood as indicating or implying relative importance or implicitly indicating the number of indicated technical features. Therefore, the feature defined as “first” or “second” may explicitly or implicitly include at least one such feature. In the description of the present disclosure, “a plurality of” means at least two, such as two, three, etc., unless otherwise specifically defined.

In the present disclosure, unless otherwise expressly defined, terms such as “install,” “interconnect,” “connect,” and “fix” shall be understood broadly, and may be, for example, fixed connections, detachable connections, or integral connections; may also be mechanical or electrical connections or intercommunication; may also be direct connections or indirect connections via intervening media; and may also be inner communications or interactions of two elements, unless otherwise specified. For those skilled in the art, the specific meanings of the above terms in the present disclosure can be understood in specific situations.

In the present disclosure, unless otherwise expressly defined and specified, a structure in which a first feature is “on” or “below” a second feature may include an embodiment in which the first feature is in direct contact with the second feature, or may further include an embodiment in which the first feature and the second feature are in indirect contact through intermediate media. Furthermore, a first feature “on,” “above,” or “on top of” a second feature may include an embodiment in which the first feature is right or obliquely “on,” “above,” or “on top of” the second feature, or just means that the first feature is at a height higher than that of the second feature, while a first feature “below,” “under,” or “on bottom of” a second feature may include an embodiment in which the first feature is right or obliquely “below,” “under,” or “on bottom of” the second feature, or just means that the first feature is at a height lower than that of the second feature.

In the description of the present disclosure, terms such as “an embodiment,” “some embodiments,” “an example,” “a specific example,” or “some examples” mean that a particular feature, structure, material, or characteristic described in connection with the embodiment or example is included in at least one embodiment or example of the present technology. Thus, the appearances of these terms in various places throughout this specification are not necessarily referring to the same embodiment or example of the present technology. Furthermore, the particular features, structures, materials, or characteristics may be combined in any suitable manner in one or more embodiments or examples. In addition, without contradiction, those skilled in the art may combine and unite different embodiments or examples or features of the different embodiments or examples described in this specification.

Although embodiments of the present technology have been shown and described above, it can be understood that the above embodiments are illustrative and shall not be understood as a limitation to the present technology, and changes, modifications, alternatives, and variations can be made in the above embodiments within the scope of the present technology by those skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A step mounting assembly, comprising:
a first support arm;
a second support arm; and
a step bracket having a first side and a second side that are oriented away from each other in a transverse direction of the step bracket, wherein at least one of the first side and the second side is connectable to a step, the first support arm is pivotally connected to the step bracket, and the second support arm is pivotally connected to the step bracket, to allow the step bracket and the step connected to the step bracket to move between an extended position and a retracted position.

2. The step mounting assembly according to claim 1, wherein at least one of the first side and the second side is provided with a bracket mating portion that is connectable to the step.

3. The step mounting assembly according to claim 2, wherein the bracket mating portion comprises a plurality of prisms arranged at intervals in a longitudinal direction of the step bracket.

4. The step mounting assembly according to claim 2, wherein the step mounting assembly further includes an end cap, the end cap is provided with an end cap mating portion, both the first side and the second side are provided with the bracket mating portion, the end cap mating portion is fitted with the bracket mating portion of one of the first side and the second side, so as to connect the end cap to the step bracket, and an outer peripheral profile of an end face of the end cap is substantially flush with an outer peripheral profile of a side surface of the step bracket.

5. The step mounting assembly according to claim 2, wherein the step mounting assembly further comprises an end cap, and one of the first side and the second side is provided with the bracket mating portion, the end cap is connected to the other one of the first side and the second side or is integrally formed with the step bracket, and an outer peripheral profile of an end face of the end cap is substantially flush with an outer peripheral profile of a side surface of the step bracket.

6. The step mounting assembly according to claim 1, wherein:
the step bracket is generally U-shaped and has a step bracket slot, the step bracket comprises a first sidewall, a second sidewall, and a connecting portion, and the step bracket slot opens inward; and
the first support arm has a first end and a second end along a length direction of the first support arm, the second support arm has a first end and a second end along a length direction of the second support arm, the second end of the first support arm is pivotally connected to the step bracket within the step bracket slot, and the second end of the second support arm is pivotally connected to the step bracket within the step bracket slot, wherein a third pivot axis of the second end of the first support arm is located at an inner side of a fourth pivot axis of the second end of the second support arm.

7. The step mounting assembly according to claim 6, wherein:
in the extended position, a length of the first support arm located within the step bracket slot is L3a, and in the retracted position, a length of the first support arm located within the step bracket slot is L3b, wherein L3a is less than L3b; and
in the extended position, a length of the second support arm located within the step bracket slot is L4a, and in the retracted position, a length of the second support arm located within the step bracket slot is L4b, wherein L4a is less than L4b.

8. The step mounting assembly according to claim 1, wherein the first support arm has a first end and a second end along a length direction of the first support arm, the second support arm has a first end and a second end along a length direction of the second support arm, the first end of the first support arm has an accommodating groove, and the first end of the second support arm is accommodated within the accommodating groove.

9. The step mounting assembly according to claim 8, wherein the first end of the second support arm comprises a cylindrical portion accommodated within the accommodating groove.

10. The step mounting assembly according to claim 8, wherein the step mounting assembly further comprises a retaining plate installed at the first end of the first support arm and configured to prevent the first end of the second support arm from disengaging from the accommodating groove.

11. The step mounting assembly according to claim 1, wherein the first support arm has an arm slot extending along a length direction of the first support arm, and a portion of the second support arm is accommodated within the arm slot.

12. The step mounting assembly according to claim 1, wherein the step mounting assembly further comprises a mounting bracket, the first support arm has a first end and a second end along a length direction of the first support arm, the second support arm has a first end and a second end along a length direction of the second support arm, the first end of the first support arm is connected to the mounting bracket and is pivotable about a first pivot axis, the second end of the first support arm is connected to the step bracket and is pivotable about a third pivot axis, the first end of the second support arm is connected to the mounting bracket and is pivotable about a second pivot axis, and the second end of the second support arm is connected to the step bracket and is pivotable about a fourth pivot axis, wherein the first pivot axis is located at an inner side of the second pivot axis, and the third pivot axis is located at the inner side of the fourth pivot axis.

13. The step mounting assembly according to claim 12, wherein:
the mounting bracket has a mounting bracket slot extending along a length direction of the mounting bracket, the first end of the first support arm is pivotally connected to the mounting bracket within the mounting bracket slot, and the first end of the second support arm is pivotally connected to the mounting bracket within the mounting bracket slot;
in the extended position, a length of the first support arm located within the mounting bracket slot is L1a, and in the retracted position, a length of the first support arm located within the mounting bracket slot is L1b, wherein L1a is less than L1b; and
in the extended position, a length of the second support arm located within the mounting bracket slot is L2a, and in the retracted position, a length of the second support arm located within the mounting bracket slot is L2b, wherein L2a is less than L2b.

14. The step mounting assembly according to claim 12, wherein in the retracted position, an upper surface of the step bracket is adjacent to an underside surface of the mounting bracket.

15. The step mounting assembly according to claim 12, wherein in the retracted position, in a plane orthogonal to the first pivot axis, an outer edge of the step bracket is located at the inner side of the second pivot axis.

16. The step mounting assembly according to claim 12, wherein in a plane orthogonal to the first pivot axis, an outer edge of the step bracket is located at an inner side of the first pivot axis, or is aligned with the first pivot axis in an up-down direction, or is located at an outer side of the first pivot axis and adjacent to the first pivot axis.

17. A retractable step device, comprising:
at least one step having a tread surface; and
a plurality of step mounting assemblies, each comprising:
a first support arm;
a second support arm; and
a step bracket having a first side and a second side that are oriented away from each other in a transverse direction of the step bracket, wherein at least one of the first side and the second side is connected to the at least one step, the first support arm is pivotally connected to the step bracket, and the second support arm is pivotally connected to the step bracket, to allow the step bracket and the at least one step connected to the step bracket to move between an extended position and a retracted position,
wherein in step brackets of adjacent step mounting assemblies, a first side of one step bracket faces a second side of another step bracket, and the at least one step is connected between the first side of the one step bracket and the second side of the another step bracket.

18. The retractable step device according to claim 17, wherein each step mounting assembly comprises a first step mounting assembly and a second step mounting assembly, a first end of the at least one step is connected to a first side of a step bracket of the first step mounting assembly, and a second end of the at least one step is connected to a second side of a step bracket of the second step mounting assembly.

19. The retractable step device according to claim 17, wherein:
each step mounting assembly comprises a first step mounting assembly, a second step mounting assembly, and at least one intermediate step mounting assembly located between the first step mounting assembly and the second step mounting assembly; and
the at least one step comprises at least a first step and a second step, a first end of the first step is connected to a first side of a step bracket of the first step mounting assembly, a second end of the first step is connected to a second side of a step bracket of one intermediate step mounting assembly, a first end of the second step is connected to a first side of the step bracket of the one intermediate step mounting assembly or a first side of a step bracket of another intermediate step mounting assembly, and a second end of the second step is connected to a second side of a step bracket of the second step mounting assembly.

20. A vehicle apparatus, comprising a vehicle and a retractable step device, wherein the retractable step device comprises at least one step having a tread surface and a plurality of step mounting assemblies, and each step mounting assembly comprises:
a first support arm and a second support arm, the first support arm and the second support arm being respectively pivotally connected to an underside of a body of the vehicle; and
a step bracket having a first side and a second side that are oriented away from each other in a transverse direction of the step bracket, wherein at least one of the first side and the second side is connected to the at least one step, the first support arm is pivotally connected to the step bracket, and the second support arm is pivotally connected to the step bracket, to allow the step bracket and the at least one step connected to the step bracket to move between an extended position and a retracted position,
wherein in step brackets of adjacent step mounting assemblies, a first side of one step bracket faces a second side of another step bracket, and the at least one step is connected between the first side of the one step bracket and the second side of the another step bracket.
